(19) United States
(12) Patent Application Publication
(10) Pub. No.: US 2026/0289144 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/567,027

(22) Filed: Mar. 14, 2026

(30) Foreign Application Priority Data
Mar. 19, 2025 (JP) 2025-045011

(51) Int. Cl. G06F 40/35; G06F 40/211; G06F 40/284; G06N 3/0475; G06V 10/62; G06V 10/764; G06V 10/82; G06V 20/40; G06V 40/16; G10L 25/03; G10L 25/63; G10L 25/90

(52) U.S. Cl. CPC G06F 40/35; G06F 40/211; G06F 40/284; G06N 3/0475; G06V 10/62; G06V 10/764; G06V 10/82; G06V 20/46; G06V 20/49; G06V 40/168; G10L 25/03; G10L 25/63; G10L 25/90

(57) ABSTRACT

A system includes a processor that is configured to obtain personal or family information, generate an assumed personality by using a generative AI model based on the obtained personal or family information, and recognize an emotion of a user and adjust a dialogue with the assumed personality based on the recognized emotion.

### CROSS-REFERENCE TO RELATED APPLICATION

This application is based on and claims priority under 35 USC 119 from Japanese Patent Application No. 2025-045011 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, digital information such as photographs, videos, audio recordings, text messages, and social media posts relating to individuals and families has been accumulated in large quantities. However, conventional systems mainly provide simple browsing, search, or static memorial content generation, and do not sufficiently support an interactive pseudo-reunion experience that reflects the personality and emotional relationship of a specific person. In particular, there is a need for a system that can dynamically generate an assumed personality based on diverse personal or family information, and can conduct a dialogue with a user in a manner that appropriately responds to the user's current emotional state. Existing dialogue systems generally do not adjust the conversational content or tone based on continuous recognition of the user's emotions within the context of a specific, generated persona. As a result, users are unable to obtain a natural and personalized narrative experience, such as reliving memories with a loved one or continuing unfinished conversations, in a way that is emotionally attuned and story-like. Accordingly, there is a demand for a system that can obtain personal or family information, generate an assumed personality by using a generative AI model, recognize the user's emotion during interaction, and adjust the dialogue with the assumed personality based on the recognized emotion so as to realize an emotionally adaptive virtual reunion as a story experienced by the user.

### SUMMARY

In order to solve the above-described problems, according to one aspect of the present invention, there is provided a system comprising a processor, wherein the processor is configured to obtain personal or family information, generate an assumed personality by using a generative AI model based on the obtained personal or family information, and recognize an emotion of a user and adjust a dialogue with the assumed personality based on the recognized emotion. The processor may obtain the personal or family information through data linkage with external services and storage systems, thereby aggregating photographs, videos, audio recordings, text messages, and social media posts relating to a specific individual or family member. The processor may analyze such information to extract linguistic, behavioral, and contextual features, and may input the extracted features to the generative AI model to construct the assumed personality that reflects characteristic expressions, topics, and relational context of the target person. During interaction with the user, the processor may continuously recognize the user's emotion from input modalities including text, voice, and optionally image information, estimate an emotional state such as joy, sadness, nostalgia, or anxiety, and adapt at least one of a response content, response tone, or dialogue progression of the assumed personality according to the emotional state. By controlling the dialogue with the assumed personality so that it follows a narrative structure corresponding to the user's memories and emotional changes, the processor can realize a virtual reunion as a story experienced by the user, thereby providing an interactive and emotionally responsive experience that addresses the above-mentioned need.

The term “personal or family information” refers to digital or analog information associated with a specific individual or with multiple individuals related by family or a similar personal relationship, including but not limited to photographs, videos, audio recordings, text messages, e-mails, documents, diaries, and social media posts, as well as metadata thereof. The term “obtain” refers to acquiring, receiving, importing, or otherwise accessing data or information from one or more sources, including local storage, network storage, external services, or user input, in a manner that allows the processor to process the data or information.

The term “generative AI model” refers to a machine learning model, such as a neural network or a combination of neural networks, configured to generate new data or content (including text, audio, or other modalities) based on patterns learned from training data and conditioned on input features or prompts.

The term “assumed personality” refers to a computational model or representation of a person's conversational style, preferences, characteristic expressions, and behavioral tendencies, generated by the generative AI model from personal or family information, and used to produce outputs, such as dialogue responses, that simulate the manner in which the person might communicate.

The term “emotion of a user” refers to an estimated or inferred affective state of the user, such as joy, sadness, anger, fear, anxiety, nostalgia, or calmness, derived from the user's inputs or behaviors by analysis of modalities including, but not limited to, text, voice, and images.

The term “recognize an emotion” refers to detecting, estimating, or classifying a user's emotional state by processing user input or interaction data with one or more algorithms, such as natural language analysis, speech analysis, image analysis, or physiological signal analysis.

The term “dialogue” refers to an interactive exchange of information or content between the user and the assumed personality, conducted through one or more modalities including text messages, voice communication, graphical user interfaces, or combinations thereof.

The term “adjust a dialogue” refers to modifying one or more aspects of the dialogue, including but not limited to response content, response timing, response style, emotional tone, topic selection, or dialogue flow, based on specified conditions such as a recognized emotion of the user.

The term “data linkage” refers to communication and integration between the system and one or more external systems, services, platforms, or databases, through application programming interfaces or other communication methods, for the purpose of acquiring, synchronizing, or updating personal or family information.

The term “virtual reunion” refers to an experience provided by the system in which the user interacts with the assumed personality in a simulated environment or interface, thereby recreating or approximating the feeling of meeting or conversing again with a specific person who is absent, unavailable, or deceased.

The term “story experienced by the user” refers to a sequence of interactions, dialogues, and presented content organized or perceived as a narrative, in which the user subjectively experiences a progression of events, memories, and emotional transitions in connection with the virtual reunion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

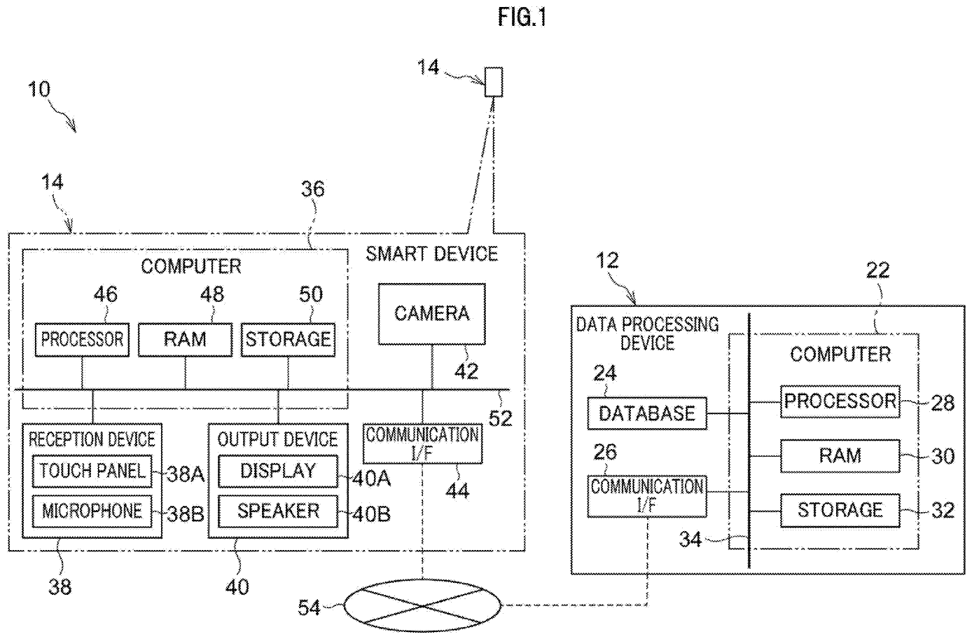

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

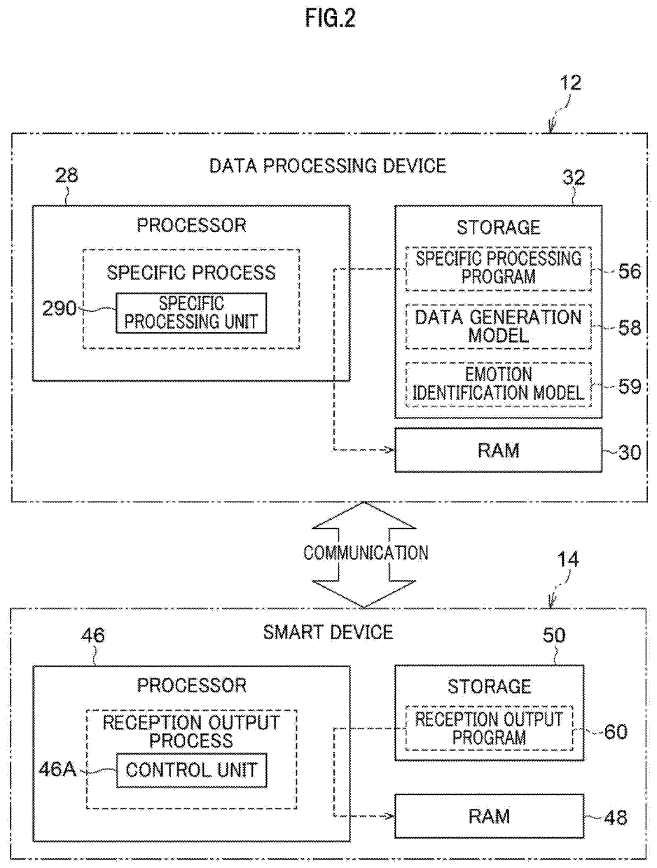

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented memory support systems and dialogue systems primarily rely on static retrieval of digital content such as photos, messages, and videos, or on generic conversational agents that are not aligned with a specific individual's personality and history. Such systems typically (i) search media collections using simple metadata or keyword matching, (ii) present results as isolated items without coherent narrative context, and (iii) generate responses using general-purpose conversational models that do not faithfully reflect the language style, emotional tendencies, or characteristic behaviors of a particular person or group. As a result, these systems fail to provide a technically robust mechanism for reconstructing past experiences in a personalized, context-aware dialogue that can be perceived as a virtual reunion with a specific person.

From a computer-technology standpoint, known dialogue engines and media-management platforms exhibit several technical limitations. First, they do not integrate heterogeneous multimodal personal data (images, videos, audio, text, social postings) into a unified personality representation that can be programmatically consumed by a generative AI model. Second, they lack an efficient data structure that couples user prompts with semantically relevant “memory units” derived from such multimodal data, using vectorized representations and similarity search to feed context back into a dialogue pipeline. Third, they do not dynamically adapt dialogue control parameters—such as response style, level of detail, or emotional tone—based on an estimated user emotional state at runtime, thereby underutilizing the available computing resources and model capacity to optimize user-specific behavior.

Moreover, conventional architectures typically treat generative models and data retrieval components as separate, loosely coupled modules. This separation leads to redundant processing of context, inefficient use of memory and bandwidth, and suboptimal coherence of generated responses. For example, a conversational engine may repeatedly query a backend datastore with shallow queries and then construct prompts in an ad hoc manner, resulting in inconsistent narratives and increased latency. The absence of a dedicated memory index structure for personal experiences linked to a personality-conditioned generative model prevents the system from producing responses that are both technically consistent and semantically grounded in the user's historical data.

Accordingly, there is a need for an improved computer-implemented system and method that (i) acquire and preprocess multimodal personal data, (ii) construct a structured personality model and a memory index optimized for similarity-based retrieval, (iii) generate integrated prompts for a generative AI model that combine personality information, retrieved memory elements, and user prompt sentences, and (iv) adapt the model's dialogue behavior based on real-time user emotion estimation. Such a system should improve the functioning of the computer itself by providing a specialized data pipeline, storage structures, and model-orchestration logic that enable efficient, consistent, and context-rich reconstruction of past experiences as a virtual reunion experience for the user.

The specific processing by the specific processing unit 290 of the data processing device 12 in Example 1 is realized by the following means.

The present invention provides a server comprising at least one processor and at least one memory storing instructions which, when executed by the at least one processor, cause the server to acquire, via a communication interface, person-related and group-related electronic information from one or more external information processing systems, store the electronic information in a storage device, preprocess the electronic information by performing multimodal analysis including language analysis on textual and audio content to extract expression-tendency information and emotion-tendency information and feature extraction on image and video content to extract subject-feature information and scene-feature information, and integrate the extracted information to generate personality information; construct, based on the personality information and the electronic information, a dialogue data processing model serving as an assumed personality by using a generative AI model, and store the dialogue data processing model in the storage device; generate, for memory elements derived from the electronic information, description information, convert the description information into feature vectors by vectorization processing, and store the feature vectors in a memory index structure configured for similarity search; receive, from a user terminal, a prompt sentence as user input, convert the prompt sentence into a prompt feature vector by the vectorization processing, perform similarity search on the memory index structure using the prompt feature vector to identify memory elements related to the prompt sentence, and generate integrated prompt information for the generative AI model by combining dialogue control information corresponding to the assumed personality, context information based on the identified memory elements, and the prompt sentence; input the integrated prompt information to the generative AI model to cause the generative AI model to generate a response sentence in the voice of the assumed personality; estimate a user emotion based on user state information, and modify the dialogue control information included in the integrated prompt information according to the estimated user emotion so as to adjust at least one of a response style and response content of the response sentence; and output the generated response sentence together with visual or auditory information associated with the memory elements to the user terminal for presentation to a user as a reconstruction of past experiences in the form of a virtual reunion. This enables an improvement in computer technology by providing a specialized, integrated architecture in which multimodal personal data are transformed into structured personality and memory indices, user prompt sentences are algorithmically bound to relevant memory elements via vector-based similarity search, and generative AI model behavior is dynamically controlled through personality-aware and emotion-aware prompt construction, thereby enhancing computational efficiency, context coherence, and the technical quality of personalized dialogue generation.

The term “processor” refers to one or more hardware computation units, such as a central processing unit or an execution core, that are configured to execute stored instructions to perform data processing operations.

The term “electronic information” refers to digitally represented data relating to at least one person or at least one group, including at least one of image information, moving image information, audio information, character information, and posting information.

The term “image information” refers to still-picture data acquired or stored in a digital format, including at least one of photographs, graphics, and other two-dimensional visual data files.

The term “moving image information” refers to time-sequential visual data acquired or stored in a digital format, including at least one of video data, animation data, and other multi-frame visual content.

The term “audio information” refers to acoustic data acquired or stored in a digital format, including at least one of recorded speech, environmental sounds, music, and other sound signals.

The term “character information” refers to symbolic textual data acquired or stored in a digital format, including at least one of messages, notes, captions, and other text strings.

The term “posting information” refers to electronic information representing user-generated content distributed through an information provision service, including at least one of social postings, comments, and status updates.

The term “external information processing apparatus” refers to a remote or separate computational system or service that stores or manages electronic information and is accessible via a communication network.

The term “communication interface” refers to a hardware and software combination that enables data exchange between the server and another device or system over a communication network.

The term “storage device” refers to one or more hardware units, such as a memory device or a storage medium, configured to store electronic information, models, indices, and control data.

The term “information analysis function” refers to software-implemented procedures and algorithms that perform preprocessing, feature extraction, and interpretation on electronic information.

The term “language analysis processing” refers to a sequence of computational operations applied to textual or transcribed audio data, including at least one of tokenization, parsing, semantic analysis, and sentiment analysis.

The term “expression tendency information” refers to data representing characteristic linguistic patterns of a person or group, including at least one of frequently used phrases, stylistic choices, and syntactic preferences.

The term “emotion tendency information” refers to data representing characteristic emotional patterns associated with a person or group, including at least one of typical emotional responses, sentiment distributions, and affective tendencies.

The term “feature extraction processing” refers to computational operations applied to visual information to obtain discriminative attributes, including at least one of object features, scene features, and facial features.

The term “subject feature information” refers to data representing characteristics of persons or objects depicted in image information or moving image information, including at least one of identity-related features and appearance-related features.

The term “scene feature information” refers to data representing characteristics of environments or situations depicted in image information or moving image information, including at least one of location types, event types, and contextual attributes.

The term “personality information” refers to structured data that characterize behavioral, linguistic, and emotional attributes of a person or group, obtained by integrating expression tendency information, emotion tendency information, subject feature information, and scene feature information.

The term “generative AI model” refers to a machine-learned computational model configured to generate output data, such as natural-language text, on the basis of input data and internal parameters trained on example data.

The term “dialogue data processing model” refers to a computational configuration derived from a generative AI model that is specialized to generate conversational responses and manage dialogue flows according to personality information and context information.

The term “assumed personality” refers to a logical representation of a person or group behavior in the dialogue data processing model, characterized by personality information and used to generate responses in a specific style and tone.

The term “memory element” refers to a unit of information derived from electronic information that represents at least one past event, situation, or experience, and that can be individually indexed and retrieved.

The term “description information” refers to textual or symbolic data that summarize or describe a corresponding memory element, including at least one of narrative descriptions, tags, and attribute lists.

The term “vectorization processing” refers to a computational procedure that converts description information or a prompt sentence into a numerical feature vector in a multidimensional space.

The term “feature vector” refers to a numerical representation of information in a multidimensional vector space, suitable for similarity computation and indexing.

The term “memory index structure” refers to a data structure that stores feature vectors corresponding to memory elements and is configured to support similarity-based retrieval operations.

The term “similarity search” refers to a computational process that identifies one or more feature vectors in a memory index structure that are similar to a query feature vector according to a predefined similarity measure.

The term “input device” refers to any hardware interface through which a user can provide data to the system, including at least one of a keyboard, a pointing device, a touch-sensitive surface, and a microphone.

The term “prompt sentence” refers to a user-provided natural-language input that expresses a question, request, or instruction to be processed by the system and the generative AI model.

The term “prompt feature vector” refers to a feature vector obtained by applying vectorization processing to a prompt sentence.

The term “dialogue control information” refers to data that specify how the dialogue data processing model and the generative AI model should generate responses, including at least one of tone parameters, detail levels, and topical constraints.

The term “context information” refers to data used to provide situational background for response generation, including at least one of retrieved memory elements, conversation history, and metadata.

The term “integrated prompt information” refers to a composite input to the generative AI model that includes at least dialogue control information, context information, and a prompt sentence.

The term “response sentence” refers to natural-language output generated by the generative AI model based on integrated prompt information, representing a reply of the assumed personality.

The term “user state information” refers to data indicative of a current condition of a user, including at least one of interaction patterns, biometric signals, and behavioral cues.

The term “user emotion” refers to an estimated emotional state of a user derived from user state information, including at least one of happiness, sadness, anger, fear, and calmness.

The term “response style” refers to characteristics of form and manner in a response sentence, including at least one of politeness level, length, formality, and expressiveness.

The term “response content” refers to semantic and factual information conveyed by a response sentence, including at least one of referenced events, entities, and explanations.

The term “visual information” refers to output data that can be perceived visually by a user, including at least one of images, video segments, and graphical indicators.

The term “auditory information” refers to output data that can be perceived aurally by a user, including at least one of synthesized speech, recorded audio, and sound effects.

The term “output device” refers to any hardware interface that presents information to a user, including at least one of a display apparatus, a speaker, and a headset.

The term “virtual reunion” refers to an interactive experience in which a user engages in dialogue with an assumed personality, with responses grounded in memory elements, such that past experiences are reconstructed and presented as if the user were meeting the corresponding person again.

In the following embodiments, a server, one or more terminals, and a user cooperate to implement the claimed system. The same reference architecture can be realized using commercially available computer hardware and software components.

A server includes at least one processor, a main memory, a non-volatile storage device, and a network interface. For example, the server uses a general-purpose central processing unit such as an x86-compatible multi-core processor, a graphics processing unit for machine learning computation such as a programmable graphics accelerator, a random access memory module, and a solid-state drive. The server runs a general-purpose operating system such as a UNIX-compatible operating system and executes application software implemented in a high-level programming language. The server exposes network interfaces in the form of a web service framework such as a web application framework and a remote procedure call interface. A terminal includes at least one processor, a memory, a display apparatus, an audio output apparatus, and at least one input device such as a touch-sensitive panel, a pointing device, a keyboard, and a microphone. The terminal executes a client application implemented as a native application or as a web browser application. The client application communicates with the server over a packet-based network by using a communication protocol such as a secure hypertext transfer protocol.

A user operates the terminal to provide explicit consent, select external information sources, and input prompt sentences for interaction with the system. The user reads or listens to responses rendered by the terminal and may perform follow-up interactions according to personal objectives.

### 1. Hardware and Software Configuration of the Server

The server uses a layered software configuration including:
A web application framework, such as a generic HTTP server and routing framework, to receive and respond to network requests.
A message queue subsystem to schedule background jobs for data acquisition and model training.
A relational or document-oriented database system to store structured metadata and configuration records.
An object storage subsystem to store media files including image information, moving image information, and audio information.
A vector database or similarity search library to store and retrieve feature vectors.
A numerical computation library such as a tensor computation framework to implement the generative AI model and auxiliary neural networks.

The server uses at least one neural-network framework to implement a generative AI model that conforms to a Transformer architecture. The generative AI model includes:
An embedding layer that converts tokenized text into numerical vectors.
A plurality of self-attention layers, each including query, key, and value projection matrices and a softmax-based attention mechanism.
Feed-forward layers with non-linear activation functions.
Layer normalization and residual connections to stabilize training and inference.

The server further uses separate neural networks and algorithms for:
Natural language processing, including tokenization, part-of-speech tagging, named entity recognition, and sentiment analysis.
Image analysis, including convolutional neural networks configured with multiple convolutional layers, pooling layers, and fully connected layers to extract subject feature information and scene feature information.
Vectorization processing, using an encoder model such as a sentence embedding model that maps variable-length text to fixed-dimensional feature vectors.

These models are trained and executed on the server's graphics processing unit, using a training library that provides automatic differentiation and gradient-based optimization.

### 2. Acquisition and Preprocessing of Electronic Information

The server accesses external information processing apparatuses, such as remote data storage services, social media platforms, and messaging services, through standardized application programming interfaces. The server uses authentication protocols such as authorization frameworks to obtain access tokens. The server receives, through the communication interface, electronic information including image information, moving image information, audio information, character information, and posting information.

The server stores binary media objects in the object storage and stores associated metadata, such as timestamps, device identifiers, location coordinates, and sender and recipient identifiers, in the database. The server uses a data-access library to read and write these records in a structured format.

The server performs language analysis processing on character information and transcribed audio information. The server uses a tokenization algorithm to split input strings into tokens, such as words or subword units. The server uses a pre-trained language model or rule-based parser to identify sentence boundaries and part-of-speech tags. The server computes sentiment scores by passing token sequences through a classification network that outputs numerical probabilities for different emotion categories. The server stores expression tendency information, such as frequently occurring phrases, typical sentence lengths, and preferred grammatical structures, by aggregating these analysis results. The server stores emotion tendency information, such as distributions of positive and negative sentiment over topics and time periods, in separate database fields.

The server performs feature extraction processing on image information and moving image information. The server uses a convolutional network to compute feature maps and then computes embeddings that represent faces, objects, and scenes. The server may apply face detection and face embedding algorithms to cluster similar face representations and to assign subject identifiers when labels are available. The server uses scene classification models to categorize images into environment types, such as indoor, outdoor, kitchen, or nature. The server stores subject feature information and scene feature information in the database, associated with unique identifiers for each media item.

The server uses a speech recognition service or local speech-to-text model to convert audio information into transcribed character information. The server then applies the same language analysis processing pipeline to these transcriptions.

By organizing multimodal data in this manner, the server produces structured features that can be used to generate personality information. This integrated representation of expression tendency information, emotion tendency information, subject feature information, and scene feature information provides a technical foundation for consistently conditioning the generative AI model.

### 3. Generation of Personality Information and Assumed Personality

The server computes personality information by aggregating statistics from the analyzed data. For example, the server computes:
Frequency distributions of phrases and word n-grams used by a specific person.
Typical sentiment patterns for particular topics, such as positive sentiment during family events and neutral sentiment in work-related messages.
Common scene types and subject co-occurrence patterns, such as the frequency of a particular person appearing in outdoor recreational scenes versus indoor meal scenes.

The server represents these patterns as numerical parameters, such as probability distributions, scalar tendencies, and high-dimensional style vectors. To compute style vectors, the server uses a text embedding model that maps sentences to feature vectors in a continuous space. The server averages, clusters, or otherwise aggregates vectors for the target person's utterances to form a style representation that characterizes their typical language usage.

The server constructs a dialogue data processing model as an assumed personality by combining:
The base generative AI model's neural parameters.
Personality-specific adapter parameters, such as low-rank adaptation matrices, that modulate internal representations.
A system-level text template that encodes guidelines for behavior, such as preferred tone and topics.

The server trains the adapter parameters using supervised learning on historical conversations where the target person's messages are used as desired outputs. The server defines a loss function, such as cross-entropy over token predictions, and uses gradient descent with a specified learning rate to minimize the loss. The server updates the adapter parameters while keeping the base model weights fixed, or partially fine-tunes the base model. By constraining the adaptation to dedicated parameter subsets, the server reduces training time, memory usage, and risk of catastrophic forgetting.

The server stores the resulting dialogue data processing model configuration in the storage device, linked with the corresponding personality information and metadata. At inference time, the server loads the appropriate configuration into memory and uses it to generate responses tailored to the assumed personality.

### 4. Construction and Use of a Memory Index Structure

The server segments the electronic information into memory elements. A memory element may correspond to a single event, such as “family trip to a lake,” or to a thematically cohesive group of interactions. The server generates description information for each memory element by combining captions, text messages, dates, locations, scene classifications, and summarized content. For example, the server may generate a textual description such as: “Family fishing trip at a lake in summer, including parent and child, with photos showing a boat and fishing rods.” The server performs vectorization processing on each description information string using a sentence embedding model. This model is implemented as a neural network encoder that processes token sequences and outputs a fixed-dimensional feature vector. The server normalizes these vectors, for example by L2 normalization, and stores them in a memory index structure. The memory index structure is implemented using a vector database or similarity search library. The server organizes feature vectors into data structures such as inverted indices, clustering-based indices, or graph-based indices. The server configures similarity metrics such as cosine similarity or dot-product similarity and sets indexing parameters such as number of clusters and search depth. This enables sub-linear time retrieval of memory elements relevant to a given query.

When the user later inputs a prompt sentence, the server applies the same vectorization processing to the prompt sentence to obtain a prompt feature vector. The server then performs similarity search in the memory index structure to identify memory elements with high similarity scores. This retrieval architecture is specifically optimized for memory recall: it avoids scanning entire databases and reduces latency. Moreover, because the index is constructed with memory elements that already integrate multimodal signals, the recall operation yields contextually rich information that can be incorporated into the generative AI model's input.

This design improves computer technology by providing a specialized memory subsystem that reduces computational cost and bandwidth by focusing only on high-relevance memory elements for each prompt sentence, thereby reducing response time and improving the coherence of generated responses.

### 5. Generation of Integrated Prompt Information and Response Sentences

The server receives a prompt sentence and conversation context from the terminal. Example prompt sentences include:
“Tell me about our fishing trip with Dad when I was in elementary school.”
“Please talk about our last family New Year's celebration together.”
“Explain Mom's secret recipe for her curry, step by step.”
“Do you remember the day we moved to the new house? What happened that day?”
“How did you feel at my graduation ceremony? Please describe it as you remember.” The server uses the prompt feature vector to select multiple memory elements, and obtains corresponding description information and associated metadata. The server constructs integrated prompt information for the generative AI model by concatenating:
A system-level instruction specifying that the model should act as the assumed personality.
Dialogue control information specifying tone, level of detail, and constraints derived from personality information.
One or more memory descriptions, ordered by relevance.
A representation of recent dialogue history.
The new prompt sentence provided by the user.

The server applies a tokenization procedure compatible with the generative AI model and ensures that the integrated prompt information fits within the model's context window. If necessary, the server truncates older parts of the dialogue or lower-priority memory descriptions, using algorithms that favor retention of highly relevant and recent data. This algorithmic selection is not a simple truncation, but a heuristic procedure that uses a scoring function combining similarity scores, recency, and topic diversity. This reduces redundant information, thereby improving computational efficiency at inference time.

The server inputs the integrated prompt information to the generative AI model and performs inference. The server uses decoding parameters such as maximum token length, temperature, and nucleus sampling values to balance determinism and diversity. The generative AI model uses its multi-layer Transformer architecture to compute attention-based representations over the entire integrated prompt information and generates token-by-token outputs to form a response sentence. Because the integrated prompt information includes personality-guided constraints and memory-based context, the resulting response sentence is both stylistically aligned with the assumed personality and semantically grounded in historical data.

This integration of vector-based memory retrieval and personality-conditioned generative inference is a non-conventional orchestration that improves the computer's ability to generate coherent, personalized responses. The server reduces the need for repeated, generic database queries and avoids manual curation by the user, thereby lowering computational overhead while improving output quality.

### 6. User Emotion Estimation and Adaptive Dialogue Control

The server estimates user emotion based on user state information. The user state information may include, for example, speech prosody features, response times, interaction patterns, and optionally physiological signals obtained through sensors in the terminal. The server extracts features such as pitch variance, speaking speed, and pause durations from audio, as well as temporal patterns such as frequency of interactions and prompt sentence length changes.

The server uses a classification model, such as a neural network or a support vector machine, to map these features to an estimated user emotion category and confidence score. The server may define discrete categories such as “calm,” “sad,” or “excited,” or may represent emotion as continuous values along dimensions such as valence and arousal.

The server modifies dialogue control information-such as degree of detail, directness, and use of emotionally charged expressions-based on the estimated user emotion. For instance, when the user emotion is estimated as “sad,” the server can adjust parameters so that the generative AI model uses more comforting phrases, avoids overly intense descriptions of stressful events, and shortens responses to prevent cognitive overload. When the user emotion is estimated as “calm” or “curious,” the server may increase level-of-detail parameters to produce longer, more descriptive responses.

This adaptive control involves altering specific token-level preferences, such as biasing the language model's predicted probabilities for certain word categories via logit adjustments or soft constraints. The server thus uses a technically defined mapping from emotion estimates to generative model control signals. This provides a technical effect: the server automatically tunes the model behavior in real time to improve readability and user satisfaction, which a generic model without these control signals cannot accomplish.

### 7. Operation of the Terminal and User Interaction

The terminal provides a graphical user interface that presents a dialogue view and a media display view. The terminal sends prompt sentences and session metadata to the server and receives response sentences and media identifiers or media content. The terminal renders text in a chat layout and may display thumbnail images or play associated video and audio content. The terminal can obtain input via typed text, speech recognition, or other input modalities. The terminal can configure privacy settings and explicit consent dialogs for data access. By presenting prompts and responses in a consistent visual format, the terminal reduces user cognitive load and acts as a thin client that offloads heavy computation to the server.

The user operates the terminal to interact with the assumed personality. The user may navigate across different time periods by changing the content of prompt sentences, and the system responds by retrieving different sets of memory elements and generating corresponding responses.

### 8. Technical Effects and Improvement of Computer Technology

The described system improves computer technology in several concrete ways:
The server uses a specialized memory index structure with vectorization processing to enable efficient similarity search over memory elements. This reduces time complexity for retrieval and lowers latency compared with naive text search or human-curated browsing.
The server orchestrates a generative AI model with multiple auxiliary components—personality information, memory index, and emotion-based control—to achieve context-rich and safe response generation. This integration is implemented as explicit data flows and algorithmic logic, not as abstract “AI makes a decision.”
The server converts heterogeneous multimodal data into structured representations that can be reused across sessions without recomputation, thereby improving resource utilization and response time.
The adaptive dialogue control based on user emotion modifies parameters at the model-input level and optionally at the logit-output level, making the generative process more robust and user-specific and reducing inappropriate or irrelevant outputs.
By combining memory-based retrieval with generative modeling, the system achieves higher factual consistency than generic models that rely solely on training data; this contributes to improved accuracy and reduced output errors.

These effects arise from specific technical features: the use of vectorization processing for memory indexing, the explicit construction and application of personality information, the configuration of a dialogue data processing model as an assumed personality, and the real-time modification of dialogue control information based on computed user states. The system is not merely automating human tasks; instead, it introduces new machine-side data structures and control flows that enable the computer to operate more efficiently and intelligently than conventional architectures.

### 9. Variations and Alternative Embodiments

The server can implement the generative AI model as different types of Transformer-based architectures, such as encoder-decoder models or decoder-only models, with varying numbers of layers and attention heads. The server can use different optimization algorithms for training, such as stochastic gradient descent variants or adaptive learning-rate methods.

The server can use alternative similarity search structures, including tree-based indices or graph-based nearest neighbor structures, while still fulfilling the core concept of storing feature vectors in a memory index structure that supports efficient similarity search.

The server can implement personality information using explicit parametric vectors or rule-based templates, or a combination of both. For example, the server can define rules that enforce avoidance of certain topics under specific emotional conditions, in addition to learned style parameters.

The terminal can be a mobile device, a desktop computer, or a dedicated hardware appliance. The system can operate in different network environments, including local networks and wide area networks.

In all these embodiments, the server, the terminal, and the user cooperate to realize a system in which the server constructs personality-specific dialogue capabilities and a memory index using a generative AI model and vectorization processing, and the terminal presents these capabilities as an interactive, virtual reunion experience controlled by prompt sentences and adapted to user emotion, thereby achieving technical improvements in data processing efficiency, dialogue coherence, and personalized response quality.

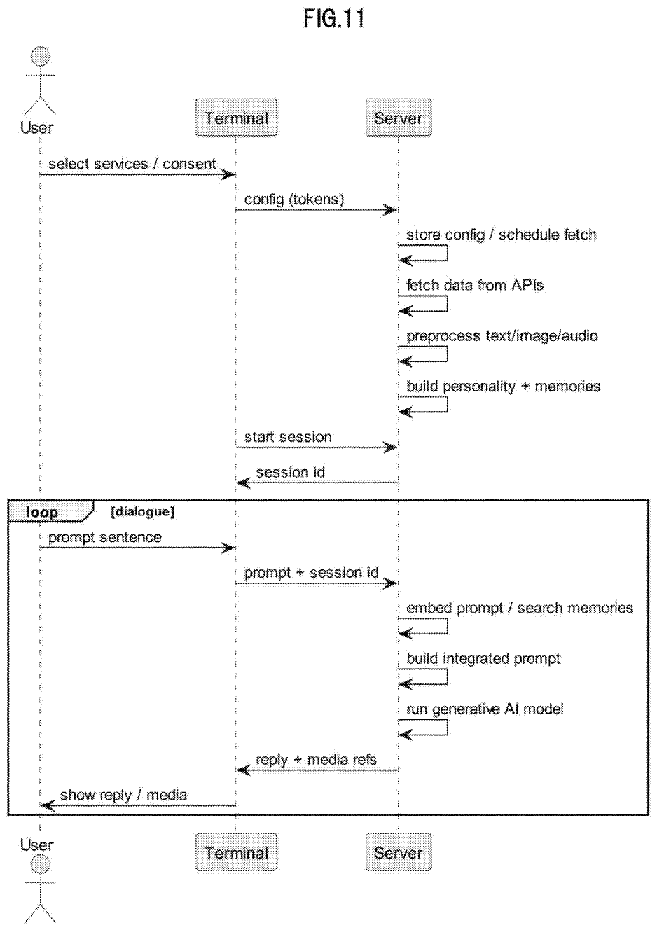

The following describes the processing flow using FIG. 11.

### Step 1:

The user configures data sources and gives consent.

The user operates the terminal to select which external services (for example, online photo storage, message services, or social platforms) are to be linked and to approve access permissions.

Input: User selections and authentication credentials entered on the terminal.

Output: Authorized access tokens and configuration parameters stored on the terminal.

The terminal displays account-connection screens, receives login information, executes authentication flows, and stores resulting tokens in secure local storage.

### Step 2:

The terminal transmits configuration information to the server.

The terminal bundles the access tokens, user identifiers, and selected options into a configuration message and sends this message to the server over a secure communication channel.

Input: Authorized access tokens and user configuration data held by the terminal.

Output: A configuration request message delivered to the server.

The terminal serializes the configuration as a structured object, attaches necessary headers, and issues an HTTP request to a configuration endpoint on the server.

### Step 3:

The server registers configuration and schedules data acquisition.

The server receives the configuration message, validates the tokens, encrypts sensitive fields, and stores them in a configuration table in a database. The server then registers background jobs for acquiring electronic information from the linked services.

Input: Configuration request including tokens, user identifiers, and data source types.

Output: Stored configuration records and enqueued acquisition tasks.

The server checks token formats, verifies signatures when applicable, writes records via a database access layer, and posts job descriptors to a job queue.

### Step 4:

The server acquires multimodal electronic information from external systems.

The server executes acquisition tasks that call external application programming interfaces to fetch image information, moving image information, audio information, character information, and posting information.

Input: Stored configuration records containing access tokens, data source endpoints, and acquisition parameters.

Output: Raw electronic information data and associated metadata stored in storage subsystems.

The server sends authenticated API requests, receives JSON responses and media files, downloads objects from remote URLs, and writes binary files to an object store while inserting metadata rows (timestamps, locations, senders, tags) into database tables.

### Step 5:

The server preprocesses text-based information.

The server reads character information and transcribed audio information from the database, applies natural language processing, and derives structured linguistic and emotional features.

Input: Text fields representing messages, posts, captions, and transcripts.

Output: Cleaned text records, token sequences, extracted entities, sentiment scores, and emotion labels stored in extended database fields.

The server normalizes character encodings, removes invalid characters, segments text into sentences and tokens, runs taggers and entity recognizers, feeds texts into sentiment classifiers, and updates each record with expression tendency features such as frequent phrases and typical sentiment distributions.

### Step 6:

The server preprocesses visual information.

The server loads image information and representative frames from moving image information, applies visual recognition models, and extracts visual features.

Input: Digital images and video frames retrieved from object storage.

Output: Subject feature information and scene feature information stored as numerical descriptors and labels in the database.

The server runs face detection and bounding-box extraction, computes face embeddings, clusters similar faces, performs object and scene classification, and records the resulting feature vectors, cluster identifiers, and scene categories as columns linked to the original media identifiers.

### Step 7:

The server converts audio information into text and analyzes it.

The server submits audio recordings to a speech recognition module, obtains transcripts, and reuses the text-processing pipeline.

Input: Audio files representing spoken content.

Output: Text transcripts enriched with the same linguistic and emotional features as other text fields.

The server segments long audio into manageable chunks, calls a speech-to-text engine, receives time-aligned transcripts, stores them as character information, and then executes tokenization, entity extraction, and sentiment classification on those transcripts.

### Step 8:

The server constructs personality information from aggregated features.

The server aggregates expression tendency information, emotion tendency information, subject feature information, and scene feature information across all data associated with a target person or group.

Input: Preprocessed feature records for text, visual, and audio data linked to one persona.

Output: Personality information including style vectors, topic preferences, emotional baselines, and behavioral statistics stored as a personality profile.

The server computes term-frequency metrics, topic distributions, sentiment histograms, co-occurrence of persons and scenes, and generates high-dimensional style vectors by averaging or clustering embedding vectors. The server bundles these values into a structured personality profile record and writes it to the database.

### Step 9:

The server adapts a generative AI model to act as an assumed personality.

The server takes the personality information and historical dialogue examples to configure or fine-tune a generative AI model into a dialogue data processing model representing the assumed personality.

Input: Personality profile data, dialogue logs, and a base generative AI model configuration.

Output: A stored dialogue data processing model and associated control parameters for the assumed personality.

The server formats training pairs from past exchanges, defines a loss function such as token-level cross-entropy, performs gradient-based optimization on adapter parameters or selected layers, and saves the resulting model weights and personality-specific prompt templates as a reusable model configuration.

### Step 10:

The server segments data into memory elements and creates description information.

The server groups related media items and messages into memory elements corresponding to specific events or episodes, then generates textual descriptions for each element.

Input: Preprocessed records including timestamps, participant lists, scene labels, and key text snippets.

Output: A set of description information strings, each linked to a memory element identifier.

The server applies rule-based grouping by date ranges, participant overlap, and location similarity, creates event-level clusters, and constructs natural-language summaries by combining key phrases, detected scenes, and basic facts for each cluster.

### Step 11:

The server performs vectorization processing and builds a memory index structure.

The server converts each description information string into a feature vector and inserts the vectors into an index optimized for similarity search.

Input: Description information strings and an embedding model configuration.

Output: A memory index structure containing feature vectors and metadata links for memory elements.

The server tokenizes each description, feeds tokens into a sentence embedding encoder to produce fixed-dimensional vectors, normalizes vectors, and inserts them into a vector database or approximate nearest neighbor structure, binding each vector to the corresponding memory element's identifier and metadata.

### Step 12:

The terminal requests initialization of a dialogue session.

The terminal sends a session-start request to the server, specifying the user identifier and the chosen assumed personality.

Input: User selection of a persona and optional mode settings at the terminal.

Output: A session identifier returned by the server and stored on the terminal.

The terminal packages the persona identifier and options into a request, sends it to the server, receives a generated session identifier in the response, and initializes a local representation of conversation history.

### Step 13:

The user inputs a prompt sentence to start or continue the dialogue.

The user types or speaks a prompt sentence on the terminal interface to ask about memories or request explanations.

Input: User-entered natural-language prompt sentence.

Output: Prompt sentence text transmitted to the server along with the session identifier.

The terminal captures the user's text or converts speech to text, associates the prompt with the current session, and sends the prompt sentence and session identifier to a dialogue endpoint on the server.

### Step 14:

The server embeds the prompt sentence and retrieves related memory elements.

The server converts the prompt sentence into a prompt feature vector and performs similarity search on the memory index structure to identify related memory elements.

Input: Prompt sentence text and the memory index structure.

Output: A ranked list of memory element identifiers and their description information.

The server tokenizes the prompt, runs the embedding encoder to obtain a vector, issues a nearest-neighbor query to the index, receives candidate vectors with similarity scores, filters them by relevance thresholds and metadata, and selects a subset of top-ranked memory elements for use as context.

### Step 15:

The server constructs integrated prompt information for the generative AI model.

The server combines dialogue control information, retrieved memory descriptions, conversation history, and the new prompt sentence into a single structured input for the generative AI model.

Input: Personality-specific control parameters, selected memory elements, prior dialogue turns, and the current prompt sentence.

Output: Tokenized integrated prompt information suitable for inference by the generative AI model.

The server serializes system instructions, inserts personality-related style directives, appends formatted memory descriptions, summarizes recent user-model exchanges, adds the current prompt sentence at the end, and converts the whole sequence into model tokens while enforcing a maximum context length.

### Step 16:

The server estimates user emotion and adjusts dialogue control information.

The server analyzes user state information to infer user emotion and modifies dialogue control parameters before or during construction of integrated prompt information.

Input: User state information such as interaction timing, previous prompt lengths, and optional sensor-derived signals.

Output: Updated dialogue control information reflecting the estimated user emotion.

The server computes feature values, feeds them into an emotion classifier to produce an emotion label or scores, maps this label to control settings such as response length and tone, and incorporates these settings into the integrated prompt information so that the generative AI model will adapt its output accordingly.

### Step 17:

The server generates a response sentence using the generative AI model.

The server runs an inference pass of the generative AI model with the integrated prompt information to produce a natural-language response sentence in the voice of the assumed personality.

Input: Tokenized integrated prompt information and decoding parameters for text generation.

Output: A generated response sentence text string.

The server feeds the token sequence into the model, computes attention and hidden states across layers, samples output tokens according to decoding settings, reconstructs the resulting tokens into natural-language text, and post-processes the text to remove incomplete sentences or unwanted artifacts.

### Step 18:

The server attaches associated media references and prepares an output payload.

The server identifies visual or auditory media linked to the selected memory elements and couples this information with the generated response sentence.

Input: Selected memory element identifiers and the response sentence.

Output: A response payload containing text and references to media files or streams.

The server queries the metadata store to retrieve file locations or thumbnails for associated images, videos, or audio clips, packages these references with the response text, and formats a structured response message for the terminal.

### Step 19:

The terminal presents the response and media to the user.

The terminal receives the response payload and renders the text and any associated media in the user interface.

Input: Response payload from the server including the response sentence and media references.

Output: Visual and auditory output displayed or played back to the user.

The terminal inserts the response sentence as a message in the dialogue view, loads images or videos from the indicated locations, displays them alongside the text, and plays audio through the speaker or connected headphones if audio content is present.

### Step 20:

The user reviews the response and optionally continues the interaction.

The user reads or listens to the response sentence and views any associated media, then decides whether to provide another prompt sentence.

Input: Rendered response and media as perceived output on the terminal.

Output: Possible new prompt sentence or termination of the session.

The user may refine the request by entering further prompt sentences such as follow-up questions or requests for additional details, and the interaction cycle returns to the prompt input stage for further processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented dialogue systems and memory-support systems suffer from several technical limitations when attempting to provide a realistic re-experiencing of past events through interaction with a virtual persona. Typical systems rely on simple keyword search, static rule-based dialogue scripts, or single-modality archives, such as plain text logs or photo galleries. As a result, such systems are unable to (i) consistently integrate heterogeneous electronic information such as images, videos, audio, and text into a coherent internal representation, (ii) retrieve past content in a manner that follows the user's evolving intent across multiple dialogue turns, and (iii) maintain temporal consistency and persona coherence when generating responses using a generative AI model.

From a computer-technology standpoint, existing architectures do not provide a unified processing pipeline that converts multi-type input data into structured “memory representation data,” nor do they construct “memory structure data” that explicitly encodes relationships among events, entities, locations, and times. Without such structured internal data representations and associated retrieval mechanisms, a processor cannot efficiently search for contextually relevant past content in response to a user's prompt sentence, and cannot reliably supply appropriate context to a generative AI model. This leads to increased computational overhead, irrelevant or temporally inconsistent responses, and degraded user experience.

Furthermore, conventional systems typically pass user prompts directly to a generative AI model without systematic semantic conversion, memory-based retrieval, or post-generation control. This results in outputs that may violate persona constraints, mix unrelated episodes, or contradict known temporal boundaries of the modeled persona. The lack of dedicated control processing, including language expression adjustment, content restriction, and temporal consistency verification, limits the reliability and safety of computer-implemented dialogue with a virtual persona.

Accordingly, there is a need for an improved computer-implemented system and processing method that: (1) normalizes and indexes heterogeneous electronic information related to an individual or group as unified memory representation data; (2) derives and maintains memory structure data that models relationships among events, entities, locations, and times; (3) converts user prompt sentences into semantic representations and retrieves relevant memory representation data on a similarity basis; (4) constructs prompt data for a generative AI model using retrieved memories and persona profile data as context; and (5) performs explicit control processing on generated dialogue response data, so that the processor can provide temporally consistent, persona-coherent, and contextually grounded dialogue that allows the user to re-experience past events.

The specific processing by the specific processing unit 290 of the data processing device 12 in Application Example 1 is realized by the following means.

The present invention provides a server comprising a processor configured to acquire, via communication with at least one external apparatus, multiple types of electronic information relating to an individual or a group, to perform format conversion, structuring, and feature extraction on the acquired electronic information, and to store the electronic information as memory representation data; to perform information processing on the memory representation data, the information processing including language processing computation, image processing computation, audio processing computation, and similarity calculation computation, so as to generate memory structure data representing relationships among events, entities, locations, and times, and to execute inference processing including a generative AI model based on the memory structure data and the memory representation data so as to generate dialogue persona profile data; to convert a prompt sentence received from a user into a semantic representation based on the dialogue persona profile data and the memory structure data, to search for memory representation data corresponding to the semantic representation on the basis of similarity, to construct prompt data to be input to the generative AI model by using the searched memory representation data and the dialogue persona profile data as context, and to cause the generative AI model to generate dialogue response data; to perform control processing on the dialogue response data, the control processing including language expression adjustment processing, content restriction processing, and temporal consistency verification processing, so as to generate adjusted dialogue response data as information data for output; and to transmit the information data to a terminal apparatus so that, via display output or audio output by the terminal apparatus, the user is provided with a re-experiencing of events through dialogue with a virtual persona. This enables a technical improvement in computer-based dialogue generation and memory retrieval, by unifying heterogeneous data into structured memory representations, by constructing and exploiting memory structure data for similarity-based retrieval and context formation, and by enforcing persona and temporal constraints through dedicated control processing, thereby allowing the processor to generate contextually relevant, temporally consistent, and persona-coherent responses that enhance the reliability and efficiency of the overall system.

The term “electronic information” refers to data in digital form, including but not limited to image data, video data, audio data, and character data, that is processable by an information processing apparatus.

The term “individual” refers to a single human subject whose related electronic information is acquired, analyzed, and used to construct a virtual persona for dialogue.

The term “group” refers to a plurality of human subjects treated collectively, whose related electronic information is acquired, analyzed, and used to construct a composite virtual persona or shared memory representation.

The term “external apparatus” refers to any information processing apparatus or storage apparatus, such as a remote server, network service, or data source, that provides electronic information via a communication interface.

The term “memory representation data” refers to structured data obtained by converting, organizing, and extracting features from heterogeneous electronic information, the structured data being suitable for storage, retrieval, and computational analysis as an internal representation of past events and related content.

The term “format conversion” refers to processing that transforms electronic information from an original encoding, structure, or medium-specific format into a standardized or normalized format suitable for unified processing and storage.

The term “structuring” refers to processing that organizes electronic information into defined data structures, records, or fields, including the association of metadata such as timestamps, identifiers, and semantic labels, so as to enable efficient retrieval and analysis.

The term “feature extraction” refers to processing that derives numerical or symbolic features from electronic information, including but not limited to embedding vectors, statistical descriptors, detected objects, or recognized words, for use in similarity calculation, classification, and inference.

The term “memory structure data” refers to data that explicitly represents relationships among events, entities, locations, and times, including linkages and graph-like associations, thereby forming a structured model of past occurrences.

The term “event” refers to an occurrence or episode associated with at least one time, place, and entity, as derived from the memory representation data and expressed within the memory structure data.

The term “entity” refers to a distinguishable object, person, or concept appearing in the electronic information, and represented as a node or element in the memory structure data.

The term “location” refers to a place or spatial context associated with events or entities, including physical places and virtual locations, as represented within the memory structure data.

The term “time” refers to temporal information, including absolute timestamps and relative temporal relations, that is associated with events and used to maintain chronological ordering and temporal consistency.

The term “information processing” refers to computational operations performed by the processor on the memory representation data, including but not limited to language processing computation, image processing computation, audio processing computation, and similarity calculation computation.

The term “language processing computation” refers to operations for analyzing and transforming textual or transcribed speech data, including tokenization, embedding generation, semantic analysis, and topic extraction.

The term “image processing computation” refers to operations for analyzing image or video frame data, including feature extraction, object detection, face detection, and visual embedding generation.

The term “audio processing computation” refers to operations for analyzing audio data, including speech recognition, acoustic feature extraction, and conversion of audio signals into text or embeddings.

The term “similarity calculation computation” refers to operations for computing a similarity measure between different items of memory representation data or between a query representation and stored data, typically based on feature vectors or embeddings.

The term “inference processing” refers to computation that derives new data or conclusions from existing data, including the use of a generative AI model to produce dialogue persona profile data and dialogue responses based on the memory structure data and memory representation data.

The term “generative AI model” refers to a machine learning model configured to generate content, such as text, based on input data and learned parameters, including but not limited to large language models used for dialogue generation.

The term “dialogue persona profile data” refers to data describing characteristics of a virtual persona, including personality traits, speaking style, typical topics, knowledge scope, and constraints, generated based on the memory structure data and memory representation data.

The term “prompt sentence” refers to a natural language input provided by a user to request information, initiate conversation, or specify a topic, which is processed by the system as a query to the virtual persona.

The term “semantic representation” refers to an internal representation of the meaning of a prompt sentence or other text, including but not limited to embedding vectors or structured semantic features used for retrieval and generation.

The term “prompt data” refers to structured input data supplied to the generative AI model, including system instructions, context derived from memory representation data and dialogue persona profile data, and at least one user prompt sentence.

The term “dialogue response data” refers to output data generated by the generative AI model in response to the prompt data, representing a candidate reply or narrative in the voice of the virtual persona.

The term “control processing” refers to post-generation processing applied to the dialogue response data, including language expression adjustment processing, content restriction processing, and temporal consistency verification processing.

The term “language expression adjustment processing” refers to operations that modify style, tone, or phrasing of dialogue response data to conform to the dialogue persona profile data or predetermined output characteristics.

The term “content restriction processing” refers to operations that remove, mask, or alter portions of dialogue response data that violate predefined rules, safety constraints, or persona-specific limitations.

The term “temporal consistency verification processing” refers to operations that check and, if necessary, correct dialogue response data so that referenced events and facts are consistent with known temporal boundaries and chronological relationships.

The term “information data for output” refers to dialogue response data after completion of control processing, which is suitable for presentation to the user via a terminal apparatus.

The term “terminal apparatus” refers to an end-user device, such as a computing device or display device, configured to receive information data from the server and to present the data through display output, audio output, or both.

The term “virtual persona” refers to a computer-generated conversational agent modeled on an individual or a group, whose behavior and utterances are controlled according to the dialogue persona profile data and memory-based context.

The term “re-experiencing of events” refers to a user's experiential perception of past occurrences reconstructed through dialogue with the virtual persona, wherein responses are grounded in memory representation data and memory structure data.

The term “narrative structure data” refers to data that arranges dialogue response data and associated memory representation data along a time axis, forming a coherent storyline corresponding to the user's interactions and the modeled past events.

In one embodiment, a server, a terminal, and a user cooperate to implement the invention. The server includes at least one processor, a main memory, a non-volatile storage unit, and a network interface. The server is implemented on a hardware platform such as a rack-mounted or virtualized computer equipped with a general-purpose central processing unit and, in some embodiments, a graphics processing unit to accelerate neural network computation. The server executes an operating system and application software that implement the functional units described below.

The server stores program modules for data acquisition, preprocessing, memory representation construction, memory structure generation, similarity-based retrieval, generative AI model interfacing, dialogue persona profile generation, control processing, and communication with the terminal. The server uses a storage system such as a relational database to manage structured records, and a file or object storage system to store binary media files.

The server acquires multiple types of electronic information relating to an individual or a group from external apparatuses. The external apparatuses include network-based storage services, social communication services, and other information processing systems that expose application programming interfaces. The server uses a network interface and communication libraries to call such interfaces over a packet-based communication network. The acquired electronic information includes image data, video data, audio data, and character data. The server stores identifiers, timestamps, source information, and media-type information for each acquired item in the storage system.

The server performs format conversion, structuring, and feature extraction on the acquired electronic information to generate memory representation data. For image and video data, the server uses image processing software to normalize image size and color space, to extract representative frames from video, and to apply object and face detection. The server converts differing file formats into a standardized internal format such as a fixed-resolution raster image or a video container with predetermined encoding parameters. For audio data, the server uses audio processing software to resample signals to a consistent sampling rate and to convert stereo signals to mono when appropriate. The server performs automatic speech recognition on speech-containing segments, thereby producing character data with corresponding time indices.

The server applies natural language processing to character data that includes text messages, transcripts, and other documents. The server segments the character data into sentences or utterances, normalizes orthography, and removes non-informative symbols. The server converts each utterance into an embedding vector using a trained neural network model that maps textual input into a continuous vector space. The server uses a similar embedding process for image data, by inputting normalized images into a convolutional or transformer-based network and extracting intermediate activations as visual feature vectors.

The server stores the resulting feature vectors, together with references to the original data items and associated metadata, as memory representation data. The memory representation data is organized in a manner that allows efficient retrieval based on similarity measures in the embedding space. The server uses data structures such as vector indices or specialized similarity search indexes to support nearest-neighbor searches.

The server generates memory structure data representing relationships among events, entities, locations, and times. The server groups memory representation data items into event-level units based on criteria such as temporal proximity, shared participants, and common locations. The server identifies entities from character data using named-entity recognition and associates these entities with events and media items. The server uses spatial or location metadata, when available, to associate geographic locations or place identifiers with events.

The server represents this information as a graph or other relational structure, where nodes correspond to events, entities, locations, and temporal markers, and edges correspond to relations such as “involves,” “occurs at,” and “precedes.” The server stores the memory structure data in a database that supports queries over node and edge properties. This explicit structuring of relationships allows the server to execute queries that respect temporal ordering and event-dependent context in a way that conventional flat log-based systems cannot.

The server generates dialogue persona profile data by analyzing portions of the memory representation data that are attributed to the individual or group being modeled. The server computes statistics of language usage, such as frequency of particular phrases, choice of vocabulary, and sentence length distributions. The server derives personality traits and stylistic descriptors from these statistics, and from higher-level clustering of topics that appear in the individual's messages and utterances.

In one embodiment, the server uses a generative AI model comprising a multi-layer neural network with attention mechanisms. The generative AI model is trained on a large corpus of human-generated text to produce probabilistic outputs conditioned on input tokens. The server adapts or conditions the generative AI model using the dialogue persona profile data. The server creates persona-specific context prompts that include characteristic phrases, typical topics, and behavioral constraints, such as temporal limits beyond which the virtual persona does not claim knowledge.

The server processes a prompt sentence received from the user. The server converts the prompt sentence into an embedding vector using the same or a compatible text embedding model that was used to generate memory representation data. The server compares this embedding vector to the stored feature vectors and retrieves memory representation data items with highest similarity according to a selected metric such as cosine similarity or Euclidean distance. The server may also apply constraints based on the memory structure data, for example by filtering candidates to those associated with a certain time interval or entity.

The server constructs prompt data for the generative AI model. The prompt data includes system-level instructions that define the behavior and role of the virtual persona, context segments derived from the retrieved memory representation data and associated memory structure data, and the current user prompt sentence. The server formats this prompt data according to the input specification of the generative AI model, which is typically a sequence of tokens with role annotations such as system, user, and context segments.

The server causes the generative AI model to generate dialogue response data by supplying the tokenized prompt data and specifying generation parameters such as maximum output length, sampling temperature, and beam width. The generative AI model internally performs attention-based computations across multiple network layers, combining information from the persona instructions, the retrieved memories, and the prompt sentence. The network computes probability distributions over vocabulary items at each step and selects output tokens to form a response sequence. The server receives the generated sequence of tokens and converts them back into character data.

The server executes control processing on the dialogue response data. The server performs language expression adjustment processing by comparing the generated text to the dialogue persona profile data. The server modifies word choices, pronouns, and tone-related markers to align the response with the predicted personality traits and typical phrasing. The server performs content restriction processing by scanning the generated text for prohibited topics or violations of specified rules, such as references to events beyond a defined temporal boundary or unsafe subject matter. The server either masks, rephrases, or regenerates portions of the response that violate these restrictions.

The server performs temporal consistency verification processing by comparing referenced times and events within the dialogue response data to the memory structure data. If the generated text asserts a sequence of events inconsistent with recorded relations, the server adjusts temporal expressions or discards conflicting segments. The server thus ensures that the final information data for output is both persona-coherent and temporally consistent with the known memory structure.

The server transmits the final information data to the terminal via the network interface. The server may include links or identifiers to associated media items, such as images or audio clips, when these are relevant to the retrieved memory representation data. The server thereby supplies both textual response content and references to additional audiovisual material.

The terminal is implemented as a computing device such as a smartphone, a wearable display device, or another user-operable information processing device. The terminal includes a processor, a display, an audio output unit, an input interface, a communication unit, and optionally a microphone and camera. The terminal executes an application that communicates with the server by sending prompt sentences and receiving information data.

The terminal presents a graphical interface that allows the user to select a virtual persona and initiate a dialogue session. The user enters a prompt sentence by typing text on an input device or by speaking into a microphone. The terminal converts speech into text using a speech recognition engine and displays the recognized text for confirmation. The terminal then transmits the text as a prompt sentence to the server.

The terminal receives the information data from the server. The terminal displays the textual portion of the response on the display and, in some embodiments, uses a text-to-speech engine to convert the text into audio for playback through the audio output unit. The terminal may also request and present images or video segments associated with the response, creating a combined presentation. This combined use of display and audio output improves the user's ability to perceive and interpret the generated content, thereby enhancing the effect of re-experiencing events.

The user experiences dialogue with the virtual persona through repeated exchanges of prompt sentences and responses. Example prompt sentences include phrases such as:

“Please recreate the memories from our last trip together to Kyoto.” “Tell me about the dish you loved to cook most.”

“How did you feel during my graduation ceremony?”

The user may refine the topic or request additional details based on previous responses. The system maintains continuity across multiple turns by using the memory structure data and dialogue persona profile data to keep track of relevant events and topics.

The server's processing contributes to a technical improvement in computer-based dialogue and memory retrieval. The transformation of heterogeneous input data into unified memory representation data and memory structure data allows the server to perform similarity-based retrieval with reduced computational cost compared to naive full-text searches or unstructured scans. The explicit embedding space and indexing structures enable sub-linear retrieval times and improved recall of semantically relevant items, thereby enhancing response accuracy and responsiveness.

The construction and use of memory structure data allow the server to enforce temporal and relational constraints in a way that conventional generative dialogue systems do not. By encoding event relationships, participant roles, and temporal order into machine-readable structures, the server can filter and rank retrieval results more effectively, reducing errors such as mixing unrelated episodes or reversing event sequences. This leads to an improvement in the reliability of generated dialogues and lowers the likelihood of contradictions.

The server's control processing module provides additional technical benefits. The language expression adjustment, content restriction, and temporal consistency verification reduce the need for repeated correction by the user and minimize the generation of irrelevant or inconsistent content. This control processing is not a simple automation of human editing but leverages structured data and embeddings to enforce constraints systematically and at scale, which would be impractical for a human to perform in real time for large memories.

The generative AI model used by the server operates according to a defined architecture and learning procedure. In one embodiment, the model is a transformer-based neural network trained with a sequence-to-sequence objective on large-scale text corpora. The network learns to minimize a loss function representing the difference between predicted and actual token sequences, with gradient-based optimization updating the network weights. When the server adapts or conditions this model for a particular persona, the server may perform additional fine-tuning using persona-specific training data or may construct specialized prompts that encode persona features. The server thereby adjusts the model's behavior without modifying the fundamental architecture, yielding persona-specific dialogue patterns that are grounded in the memory representation data.

The data flow within the server is organized into modules connected by well-defined interfaces. A data acquisition module feeds raw media into a preprocessing module. The preprocessing module outputs normalized media and initial feature vectors to a storage module. A memory construction module builds memory structure data by grouping and linking items. A retrieval module uses query embeddings and similarity metrics to select relevant memories. A persona module maintains dialogue persona profile data and injects persona constraints into the generative AI model's context. A generation module interacts with the generative AI model, and a control module refines the output before it is sent to the terminal. This modular architecture enhances maintainability and scalability, and allows independent improvement of individual components.

The described processing pipeline is not limited to one configuration. In one alternative embodiment, the server may perform some preprocessing or feature extraction using dedicated hardware accelerators, such as specialized inference chips, to further reduce processing latency. In another embodiment, the terminal may perform certain local operations, such as preliminary embedding of prompt sentences or on-device caching of frequently used persona instructions, in order to reduce communication load and server-side computation. In yet another embodiment, the memory structure data may be partitioned across multiple database instances to distribute load and provide faster access for frequently requested events.

Because the server uses a structured embedding space and graph-based memory structure, as well as post-generation control, the system achieves a level of accuracy, temporal consistency, and speed of retrieval and response generation that cannot be attained by simple human-like manual browsing of media files or by naïve keyword-based search and direct model prompting. The system thus provides an improvement to the functioning of the computer itself, enabling more efficient management of large heterogeneous data collections and more precise generation of contextually appropriate responses.

The terminal and server cooperate to implement all of the above operations in a manner that can be reproduced by a person skilled in the art, using known programming environments, computing hardware, and neural network frameworks. The described configuration, data structures, and processing sequences enable the implementation of the claimed system in various deployment environments while preserving the technical effects of improved retrieval efficiency, improved response accuracy, and enhanced temporal and persona consistency.

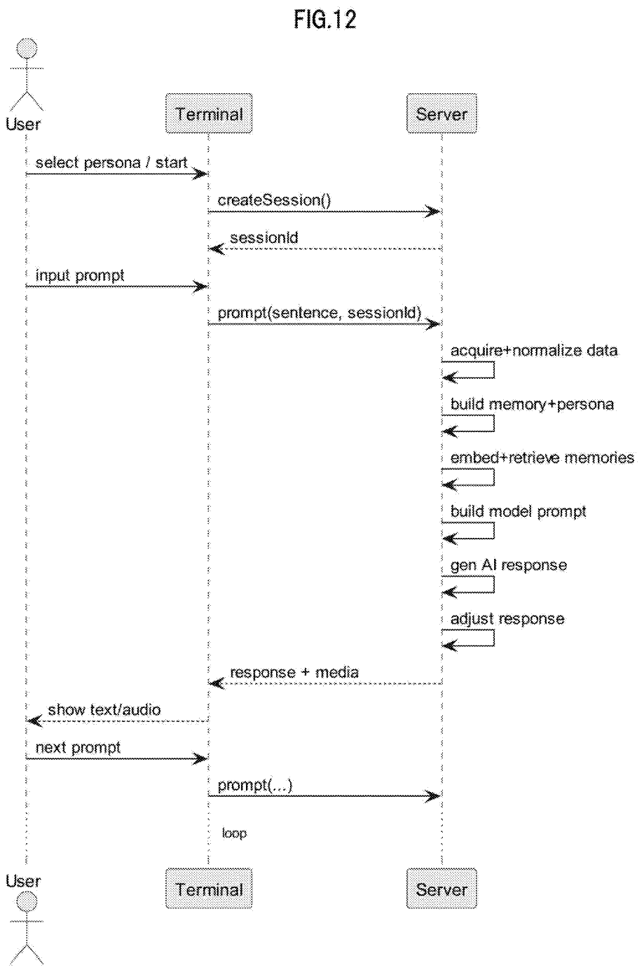

The following describes the processing flow using FIG. 12.

### Step 1:

The server acquires electronic information relating to an individual or a group.

The input to this step is one or more access tokens, connection settings, or upload requests received from the terminal.

The server uses these inputs to call external application programming interfaces or to receive uploaded files via a communication interface, and the server obtains raw image files, video files, audio files, and text documents.

The server writes the raw media files into a storage unit and records metadata such as source identifier, timestamp, and media type in a database as the output of this step.

### Step 2:

The server performs format conversion on the acquired electronic information.

The input to this step is the set of raw media files and associated metadata stored in the storage unit.

The server reads each media file and applies media-specific conversion processing, such as transcoding videos into a standard container format, converting image files to a unified resolution and color space, and resampling audio to a uniform sampling rate.

The server outputs normalized media files and updated metadata, including paths to the converted files and standardized encoding parameters, into the database.

### Step 3:

The server structures the normalized media into memory representation records.

The input to this step is normalized media files and their metadata.

The server groups files by criteria such as time intervals, common participants, or application-level identifiers, and the server generates structured records that include identifiers, timestamps, media types, and source attributes.

The server stores these structured records in a memory representation table in the database as the output of this step.

### Step 4:

The server performs feature extraction on text data to generate text embeddings.

The input to this step is character data obtained from text documents and transcripts associated with the memory representation records.

The server applies a natural language processing module that tokenizes text, removes non-informative tokens, and feeds the token sequences into a neural network encoder configured as part of a generative AI model framework or as a separate embedding model.

The server computes a numerical feature vector for each text unit and outputs a mapping from text identifiers to embedding vectors, which the server stores in a vector index.

### Step 5:

The server performs feature extraction on image and video data to generate visual embeddings.

The input to this step is normalized image files and representative frames extracted from video files.

The server feeds each image into a visual feature extractor, such as a convolutional or transformer-based neural network, and the server obtains intermediate activation values that serve as feature vectors representing visual content.

The server associates each feature vector with the corresponding media identifier and outputs the visual embeddings into the same or a related vector index.

### Step 6:

The server constructs memory structure data that encodes relationships among events, entities, locations, and times.

The input to this step is the set of memory representation records, text embeddings, visual embeddings, and metadata such as timestamps and location tags.

The server identifies candidate events by clustering records according to temporal proximity and context similarity, extracts entities from text using an entity recognition module, and links events to entities and locations.

The server outputs a structured representation, such as a graph with nodes and edges, and stores it as memory structure data in a database optimized for relational or graph queries.

### Step 7:

The server generates dialogue persona profile data.

The input to this step is memory representation data and memory structure data that specifically involve the target individual or group.

The server computes language usage statistics, extracts typical phrases, and aggregates topic distributions from the person-related text units, and then the server assembles these features into a persona description.

The server outputs dialogue persona profile data that includes personality attributes, stylistic rules, preferred topics, and temporal constraints, and the server stores this data in a profile repository.

### Step 8:

The terminal initiates a dialogue session with a selected virtual persona.

The input to this step is a user selection of a persona and a session start command entered on the terminal.

The terminal transmits a session creation request including a persona identifier to the server, and the server creates a session record that references the selected dialogue persona profile and initializes context information.

The server outputs a session identifier to the terminal, and the terminal stores it locally for use in later requests.

### Step 9:

The user provides a prompt sentence to request a memory-based dialogue.

The input to this step is user speech or text entered on the terminal, such as:

“Please recreate the memories from our last trip together to Kyoto.”

“Tell me about the dish you loved to cook most.”

“How did you feel during my graduation ceremony?”

The terminal converts any speech input into text using a speech recognition module, displays the recognized prompt sentence for confirmation, and transmits the confirmed text and the session identifier to the server.

The server receives the prompt sentence and stores it in the conversation history associated with the session as the output of this step.

### Step 10:

The server converts the prompt sentence into a semantic representation.

The input to this step is the prompt sentence text and the dialogue persona profile data.

The server tokenizes the text, feeds it into a text embedding model, and generates a feature vector that captures semantic content, and the server may apply persona-specific weighting rules to emphasize terms related to known topics.

The server outputs the resulting semantic representation as an embedding vector and uses it as a query key for retrieval.

### Step 11:

The server retrieves relevant memory representation data based on similarity.

The input to this step is the query embedding obtained from the prompt sentence and the set of stored text and visual embeddings in the vector index.

The server computes similarity metrics between the query embedding and stored embeddings using measures such as cosine similarity, and the server selects a subset of memory representation records whose embeddings exceed a similarity threshold or rank among top candidates.

The server outputs a list of retrieved memory representation data together with references to associated events in the memory structure data.

### Step 12:

The server refines the retrieved results using memory structure data.

The input to this step is the list of candidate memory representation items and the memory structure data that encodes events, entities, locations, and times.

The server checks each candidate against temporal constraints and persona-specific rules, removes candidates outside allowed time ranges, and adjusts the ranking based on event relevance and entity involvement.

The server outputs a refined set of memory items and corresponding event-level summaries to be used as contextual information in dialogue generation.

### Step 13:

The server constructs prompt data for the generative AI model.

The input to this step is the dialogue persona profile data, the refined memory items and event summaries, the current prompt sentence, and optionally prior turns in the session history.

The server concatenates system-level instructions that describe the persona and constraints, inserts selected memory snippets as context, and appends the user's prompt sentence, arranging them in a format suitable for the generative AI model.

The server outputs structured prompt data as a sequence of tokens or text segments with designated roles for system, context, and user input.

### Step 14:

The server generates dialogue response data using the generative AI model.

The input to this step is the structured prompt data and generation parameters such as maximum length and sampling behavior.

The server feeds the prompt data into the generative AI model, which performs internal neural network computations across multiple layers, using attention mechanisms to integrate persona instructions and memory context with the prompt sentence, and the model outputs a sequence of tokens representing a candidate response.

The server decodes the token sequence into natural language text and outputs this text as raw dialogue response data.

### Step 15:

The server applies control processing to the dialogue response data.

The input to this step is the raw dialogue response text, the dialogue persona profile data, and the memory structure data.

The server examines the response text and adjusts stylistic elements to match the persona profile, scans for prohibited content or references beyond allowed temporal boundaries, removes or rewrites segments that conflict with restrictions, and verifies that event references are consistent with recorded temporal relations.

The server outputs adjusted dialogue response data that has been filtered and corrected to produce information data for output.

### Step 16:

The server transmits the information data and associated media references to the terminal.

The input to this step is the adjusted dialogue response text and any identifiers of memory representation items, such as images or audio clips, that enhance the response.

The server packages the text and media references into a response message, sends it via the network interface to the terminal, and records that the response has been delivered in the session history.

The terminal receives the message as the output of this step.

### Step 17:

The terminal presents the response to the user.

The input to this step is the information data received from the server, including the dialogue text and any associated media identifiers.

The terminal renders the text on a display, optionally converts it into audio using a text-to-speech engine, retrieves and displays any associated images or video segments, and synchronizes visual and audio output for coherent presentation.

The terminal outputs a multimodal presentation to the user, allowing the user to perceive the virtual persona's reply along with related memories.

### Step 18:

The user continues the interaction based on the presented response.

The input to this step is the displayed and played-back content perceived by the user.

The user interprets the response, decides whether to request further details, clarification, or a new topic, and then provides another prompt sentence by speech or text through the terminal.

The user's new prompt sentence is output from this step as input to the terminal and server, and the interaction loop repeats from the subsequent prompt-processing steps.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems and content generation systems that employ a generative AI model are typically designed as stateless or weakly stateful services. Such systems usually generate responses based only on a current user input and, at most, a short recent history. As a result, they do not effectively integrate large-scale, heterogeneous personal data such as images, moving images, audio, and text that are accumulated over long periods of time. Therefore, these systems are unable to reconstruct and utilize user-specific memories and persona characteristics in a technically structured and consistent manner.

In typical architectures, multimedia data are stored as raw files or simple metadata records without unified feature representations. Retrieval of relevant past events in response to a user prompt sentence is frequently performed by keyword matching or simple rule-based filtering. This leads to low precision in selecting contextually appropriate memories, and causes a technical bottleneck where the generative AI model is forced to infer missing context, which increases computational waste and degrades response quality. Furthermore, conventional systems do not maintain a long-term dialogue history that is integrated with memory representations, so they cannot incrementally refine their context modeling based on continuous user interaction.

In addition, many systems treat persona emulation as a superficial style prompt layered on top of a general-purpose language model. Without a structured memory information set and a personality characteristic information set that are explicitly extracted and stored from multimedia sources, the generative AI model cannot reliably reproduce a consistent speaking style, emotional tendency, and relational characteristic over multiple sessions and large datasets. This limitation results in unstable behavior, high variability in responses, and inefficient usage of computing resources, because the model must repeatedly reconstruct persona-related cues from scratch.

Moreover, existing computing systems often lack an integrated pipeline that transforms heterogeneous personal data into unified vector representations, uses those representations for similarity-based retrieval against a large memory store, and then injects the retrieved memories into a generative AI model in a systematic way. Without such a pipeline, the system cannot efficiently locate high-relevance memories for a given prompt sentence, nor can it scale to large volumes of user data while maintaining low latency and high throughput.

There is therefore a need for an improved computer-implemented technique that (i) systematically acquires and normalizes heterogeneous user-related information, (ii) executes feature extraction processing and recognition processing to build structured memory and persona representations, (iii) retrieves semantically relevant memories for an arbitrary prompt sentence using vector-based similarity, (iv) integrates retrieved memories and persona characteristics into a generative AI model input as context information, and (v) incrementally updates dialogue behavior using an accumulated dialogue history. Such a technique should improve the functioning of the computer system itself by enhancing data organization, retrieval efficiency, and response generation consistency, thereby enabling a technically improved virtual reunion experience.

The specific processing by the specific processing unit 290 of the data processing device 12 in Example 2 is realized by the following means.

The present invention provides a server comprising a processor and a memory, the processor being configured to acquire, via communication with at least one external apparatus, information relating to a user and information relating to a group associated with the user, and to store the acquired information in the memory as normalized temporal information, attribute information, and medium-type information; to execute, on a plurality of types of information including image information, moving-image information, audio information, and character information stored in the memory, feature extraction processing, recognition processing, and summarization processing so as to generate, based on results of the processing, a memory information set corresponding to an assumed persona and a personality characteristic information set corresponding to the assumed persona, including unified vector representations of individual memories and persona traits; to construct or adjust a generative artificial intelligence model by using the memory information set and the personality characteristic information set as training data such that the model reflects a speaking style, emotional tendency, and relational characteristic of the assumed persona; to convert a prompt sentence input by the user into a vector representation, to retrieve, from the memory information set, memory information having semantic similarity to the vector representation based on similarity calculation between vectors, and to generate context information including the prompt sentence and the retrieved memory information; to supply the context information to the generative artificial intelligence model so as to generate dialogue text that responds to the prompt sentence while referring to the retrieved memory information; to generate audio data and visual display control data based on the dialogue text so as to cause a terminal device to perform audio output and visual display corresponding to the assumed persona; and to accumulate, in the memory as a dialogue history, a plurality of prompt sentences continuously input by the user and the dialogue text, and to incorporate the dialogue history into the context information for subsequent dialogue text generation. This enables the computer system to technically improve its internal data representation and retrieval mechanisms, to efficiently identify and exploit relevant user-specific memories for each prompt sentence, and to generate consistent persona-based dialogue with reduced computational redundancy and enhanced response quality, thereby providing an improved virtual reunion experience implemented by the underlying computing architecture.

The term “user” refers to an individual who operates a terminal device and inputs one or more prompt sentences to interact with an assumed persona through the system.

The term “group” refers to a plurality of individuals associated with the user, including but not limited to family members, friends, or colleagues, whose related information is used to construct memory information and persona characteristics.

The term “external apparatus” refers to any computing resource or communication endpoint, including network-connected servers, storage services, or application programming interfaces, from which user-related or group-related information is acquired by the system.

The term “storage area” refers to a physical or logical memory component, such as a main memory, a secondary storage device, or a database, configured to store information, feature data, and dialogue history used by the processor.

The term “temporal information” refers to data indicating time-related attributes of acquired information, including timestamps, time intervals, and chronological ordering associated with events or records.

The term “attribute information” refers to descriptive metadata associated with acquired information, including identifiers, relationship labels, categories, locations, or other classification attributes.

The term “medium-type information” refers to data indicating a type or format of acquired content, including whether the content is image information, moving-image information, audio information, or character information.

The term “image information” refers to still visual data, such as photographs or static graphics, represented by raster or vector formats and associated metadata.

The term “moving-image information” refers to time-sequential visual data, such as video sequences or animated content, comprising multiple image frames and associated temporal metadata.

The term “audio information” refers to sound data, including speech, music, or ambient noise, represented in a digital audio format and optionally associated with timing and speaker metadata.

The term “character information” refers to text data, including written messages, captions, posts, or transcripts, represented as sequences of characters or tokens.

The term “feature extraction processing” refers to computational operations that derive numerical or symbolic feature values from raw data, such as vectors representing faces, objects, prosody, or lexical patterns.

The term “recognition processing” refers to computational operations that identify or classify elements within data, including detection of faces, scenes, objects, speakers, topics, or emotions.

The term “summarization processing” refers to computational operations that condense one or more pieces of information into a shorter representation, including generation of textual summaries describing events or memories.

The term “memory information set” refers to a structured collection of data records representing past events or experiences related to the user or the group, each record including content, features, and associated metadata.

The term “personality characteristic information set” refers to a structured collection of data representing traits of an assumed persona, including speaking style, emotional tendencies, preferred topics, and relational characteristics.

The term “assumed persona” refers to a virtual personality modeled to emulate characteristics of an individual or group related to the user, including linguistic style, emotional behavior, and relational context.

The term “generative artificial intelligence model” refers to a machine-learned model configured to generate output data, such as textual responses, based on input data and internal parameters, typically implemented using a neural network architecture.

The term “persona model” refers to an instance or configuration of the generative artificial intelligence model that has been constructed or adjusted so as to reflect the speaking style, emotional tendency, and relational characteristic of the assumed persona.

The term “prompt sentence” refers to a user-provided input expression, including a sentence or phrase, that requests information, memories, or dialogue from the assumed persona.

The term “semantic similarity” refers to a measure of closeness between meanings of two or more pieces of information, computed using vector-based or other representation techniques.

The term “vector representation” refers to a numerical representation of information, such as a prompt sentence or a memory record, in the form of a multi-dimensional vector suitable for similarity computation.

The term “context information” refers to combined data supplied to the generative artificial intelligence model, including at least a prompt sentence, retrieved memory information, persona characteristics, and optionally dialogue history.

The term “dialogue text” refers to textual content generated by the generative artificial intelligence model in response to a prompt sentence, intended to represent an utterance of the assumed persona.

The term “audio data” refers to digital sound data generated based on dialogue text, suitable for playback by a terminal device to output speech corresponding to the assumed persona.

The term “visual display control data” refers to control parameters or signals generated based on dialogue text or audio data, used to drive visual output, such as avatars, animations, or graphical elements, on a terminal device.

The term “terminal device” refers to an end-user computing device, such as a portable device, a stationary device, or a display apparatus, configured to communicate with the server, receive output data, and present audio and visual content to the user.

The term “virtual reunion experience” refers to an interactive presentation in which the user perceives communication with the assumed persona through generated dialogue text, audio output, and visual display based on personal or group-related memories.

The term “dialogue history” refers to an accumulated record of user inputs, including prompt sentences, and system outputs, including dialogue text, stored for use in subsequent context generation and response adaptation.

In one embodiment, a server implements the claimed system by executing a plurality of software modules on general-purpose computer hardware. The server includes at least one central processing unit (CPU), a graphics processing unit (GPU), a main memory, a non-volatile storage device, and a network interface controller. The server executes an operating system such as a general-purpose server operating system and runs application software components including a data acquisition module, a feature extraction module, a memory and persona construction module, a generative AI serving module, and an output synthesis module. The server communicates with at least one terminal over a network such as the Internet or a local area network.

The server uses a database system and an object storage system to implement a storage area. For example, the server uses a relational database to store structured metadata, feature vectors, and dialogue history, and uses a distributed object storage system to store large binary objects including image files, video files, and audio files. The server stores temporal information, attribute information, and medium-type information as explicit fields in database tables. Temporal information includes timestamps and time ranges. Attribute information includes user identifiers, group identifiers, relationship labels, and location descriptors. Medium-type information includes enumeration values indicating image information, moving-image information, audio information, and character information.

The server acquires information relating to a user and information relating to a group associated with the user by communicating with external apparatuses via application programming interfaces. The server sends authenticated requests to external storage services, communication services, or social information services and receives response data including metadata and content data. The server parses response messages in a structured format and converts them into internal records. The server registers each record in the storage area with a unique identifier, temporal information, attribute information, and medium-type information. By normalizing heterogeneous inputs into a unified schema, the server reduces subsequent parsing overhead and enables efficient access paths for later retrieval operations.

The server executes feature extraction processing and recognition processing on the stored multimedia data using dedicated software libraries. For image information and moving-image information, the server uses a media processing framework to decode media formats and extract individual frames from moving-image information. The server applies a convolutional neural network (CNN) model, such as a residual network or a similar deep network, implemented in a machine learning framework such as TensorFlow or PyTorch, to each frame to compute a feature vector representing visual characteristics. These feature vectors include face feature components, scene feature components, and object feature components. The server stores these feature vectors as fixed-length numeric arrays in the relational database and associates them with the corresponding content records.

The server processes audio information using a signal processing library. The server decodes audio files and normalizes sampling rate and amplitude. The server segments the audio information into audio segments based on silence detection thresholds. For each audio segment, the server applies a speaker recognition algorithm and a prosody analysis algorithm. The server computes speaker feature quantities, such as speaker embedding vectors, and prosodic feature quantities, such as fundamental frequency contours, energy envelopes, and speech rate. The server also uses a speech recognition engine to convert speech signals into character information, generating transcripts with time alignment. The server stores the resulting feature vectors and transcripts as part of the memory information set.

The server processes character information using a natural language processing library. The server tokenizes sentences, detects language, and computes lexical feature quantities such as token frequency distributions, part-of-speech distributions, and syntactic dependency patterns.

The server computes emotional feature quantities by applying a text-based emotion classifier that outputs scores for classes such as joy, sadness, anger, or neutrality. The server further computes topic feature quantities by applying a topic modeling algorithm or a neural embedding model that maps text segments to dense vector representations. These lexical, emotional, and topic feature quantities are stored as numerical vectors and associated with corresponding content records. The server constructs a memory information set by grouping related records across modalities. For example, the server groups an image record, an audio record, and a character record that share similar temporal information and attribute information into a composite memory record representing a single event. The server applies a summarization model implemented as a sequence-to-sequence neural network to the aggregated character information for the event and generates a short descriptive summary in natural language. The server creates a memory vector for each composite memory record by combining the visual feature vectors, audio feature vectors, and text-based embedding vectors into a single high-dimensional vector. In one embodiment, the server concatenates and projects these vectors using a learned linear transformation so that all memory vectors inhabit a common vector space.

The server constructs a personality characteristic information set by aggregating feature quantities across multiple memories attributed to the same assumed persona. The server computes statistics such as average sentence length, typical emotional distribution, preferred topics, and frequently used lexical expressions. The server also aggregates prosodic features across speech samples to determine a typical speaking rate, pitch range, and intensity pattern. The server stores these aggregated features as persona-specific profiles. In some embodiments, the server maintains multiple persona profiles corresponding to different individuals or groups related to the user.

The server constructs or adjusts a generative AI model using the memory information set and the personality characteristic information set. In one embodiment, the server uses a transformer-based neural network as the generative AI model. The network includes an embedding layer, multiple self-attention layers, feed-forward layers, and a final output layer that predicts a probability distribution over tokens. The server initializes the generative AI model from pre-trained parameters and performs fine-tuning using training samples derived from the memory information set. Each training sample consists of an input sequence and a target output sequence. The input sequence includes persona instructions derived from the personality characteristic information set and a context text portion derived from memory summaries. The target output sequence includes utterances that represent how the assumed persona would respond. The server computes a loss function, such as cross-entropy loss, between predicted token probabilities and target tokens and updates model weights using a gradient-based optimization algorithm such as Adam. During fine-tuning, the server adjusts hyperparameters such as learning rate, batch size, and regularization coefficients to stabilize training and reduce overfitting.

The server constructs a persona model by associating the fine-tuned parameters and the persona profile with a model identifier. The persona model thus embodies both the learned generative parameters and the persona-specific constraints. When a user selects a particular assumed persona, the server loads the corresponding persona model and associated memory information set into active memory.

The terminal implements a user interface for interacting with the persona model. The terminal includes at least one processor, a display apparatus, an audio output apparatus, an audio input apparatus, and a communication interface. The terminal executes an application program that renders graphical elements and controls media playback. The terminal displays an avatar or other visual representation of the assumed persona on the display apparatus. The terminal presents a text input field and a control for audio input. When the user enters a prompt sentence, either by typing or speaking, the terminal generates a request message containing the prompt sentence and session identifiers and transmits the message to the server via the communication interface. The user interacts with the system by providing prompt sentences that express a desire to recall or reconstruct past experiences. For example, the user may input prompt sentences such as:

“Mom, please tell me about our last Christmas together.”

“Mom, what did we do on my tenth birthday?”

“Mom, how did you feel when we spent that Christmas at Grandma's house?” “Mom, what gift did you give me that Christmas?”

“Mom, can you describe the smell and sounds in the living room that night?” “Mom, what did you hope for my future when we celebrated that Christmas?”

The server receives the prompt sentence, normalizes it, and converts it into a vector representation. In one embodiment, the server uses a sentence embedding model implemented in a neural network to map the prompt sentence to a fixed-length vector. The server then compares this vector with the stored memory vectors in the memory information set using a similarity metric such as cosine similarity. The server retrieves a subset of memory records corresponding to the most similar memory vectors. A threshold or a top-k selection is applied to control the number of retrieved records.

The server generates context information that combines the prompt sentence, the selected memory summaries, and persona profile information. The server constructs a structured input text that includes explicit instruction segments, memory descriptions, and the prompt sentence. This context information is supplied as input tokens to the persona model. The generative AI model processes the input through its multi-layer transformer architecture. At each layer, self-attention mechanisms compute attention scores between tokens using learned weight matrices, and the outputs are passed through non-linear feed-forward layers. The model produces hidden representations that capture both the semantics of the prompt sentence and the content of the retrieved memories.

The server generates dialogue text by sampling from the output probability distribution of the generative AI model. The server uses decoding algorithms such as nucleus sampling or top-k sampling with controlled temperature values to balance variety and fidelity. The server applies constraints derived from the persona profile to avoid text that is inconsistent with the assumed persona's characteristics. For example, the server may penalize tokens outside a persona-specific vocabulary or adjust probabilities of emotion-laden words to match the persona's typical emotional style. As a result, the generated dialogue text reflects both the retrieved memories and the persona's speaking style.

The server transforms the dialogue text into audio data by invoking a text-to-speech synthesis engine. The server selects a voice configuration that corresponds to the assumed persona. The server provides phoneme sequences and prosodic patterns based on the persona's prosodic feature quantities. The synthesis engine computes acoustic parameters and generates an audio waveform. The server also computes visual display control data, such as phoneme-aligned viseme sequences and facial expression parameters, by mapping phonetic and emotional markers in the dialogue text to animation parameters. These parameters drive an avatar engine executing on the terminal.

The terminal receives the dialogue text, audio data, and visual display control data from the server. The terminal buffers the audio data and plays it through the audio output apparatus. The terminal applies the visual display control data to animate the avatar, synchronizing lip movements and facial expressions with the speech. The terminal also displays the dialogue text as subtitles or chat messages. The user thus perceives a virtual reunion experience with the assumed persona through coordinated audiovisual output.

The server records each prompt sentence and each generated dialogue text in the storage area as dialogue history. The server maintains a conversation-level structure that stores sequences of prompt response pairs. When processing subsequent prompt sentences, the server incorporates selected elements of the dialogue history into the context information. For example, the server may append the last several exchanges or may provide a summary of prior dialogue as part of the persona instructions. This incremental incorporation of dialogue history allows the persona model to maintain continuity and adapt to user preferences over time.

The described configuration improves computer technology beyond mere automation of human tasks in several ways. First, by storing heterogeneous multimedia data as unified vector representations that combine visual, audio, and text features, the server enables efficient similarity search over large datasets. The use of vector-based retrieval for memory information sets reduces search time and improves precision compared to keyword-based or rule-based retrieval, especially for prompt sentences that do not share exact words with stored content. Second, by decoupling the memory information set and the persona characteristic information set and by providing explicit data structures for both, the system reduces the need for the generative AI model to infer persona information in an ad hoc manner from each individual prompt. This reduces computational redundancy and stabilizes output behavior, resulting in fewer required inference steps and lower model perplexity.

Third, the server employs a non-conventional processing pipeline where retrieval of memory information is performed before generation, and the retrieved memory information is directly embedded into the context presented to the generative AI model. This retrieval-augmented architecture enables the model to focus its capacity on transforming structured contextual information into text, rather than searching a large parameter space for implicit memories. As a result, the system can use smaller models or fewer computation resources for equivalent or improved performance, which is a concrete improvement in computational efficiency.

Fourth, the integration of dialogue history into context information is performed using specific rules that avoid unbounded growth of context length. The server may, for example, summarize older dialogue segments or prune low-relevance exchanges based on similarity to the current prompt sentence. This maintains a bounded input length to the generative AI model and reduces processing time and memory usage, thus improving throughput and scalability. These techniques are not simple human-like summarization but are implemented through algorithms that use quantitative similarity measures and explicit thresholds to manage computational load.

Fifth, the server's control over audio and visual output is driven by structured control data derived from model outputs and persona profiles, rather than by human-designed scripts. The server maps linguistic and prosodic features to animation parameters in a deterministic pipeline. This mapping enables precise synchronization between audio and visual components and allows the system to adapt to arbitrary generated content without manual editing, thereby enhancing the technical performance of the multimedia rendering subsystem.

Alternative embodiments are also possible. In one variation, the server may use a recurrent neural network architecture or a hybrid architecture instead of a pure transformer architecture for the generative AI model, while still using the same memory information set and persona characteristic information set. In another variation, the vector representation of memory information may be constructed using a graph neural network that encodes relationships between individuals and events. In a further variation, the similarity search may be performed using approximate nearest neighbor algorithms with different index structures to reduce retrieval latency. The system may also adjust learning strategies, such as using different loss functions, regularization methods, or data augmentation techniques, to adapt to different datasets or performance requirements.

In all of these embodiments, the server, the terminal, and the user cooperate through defined data flows and processing sequences. The server performs the intensive computation required to build and update the generative AI model, to maintain and search the memory information set, and to synthesize multimodal outputs. The terminal provides localized rendering and user interaction, while the user supplies prompt sentences that guide the retrieval and generation of content. By organizing data and computation in this manner, the system achieves technical effects including improved retrieval accuracy, reduced inference time, better utilization of computing resources, and consistent persona-based interaction across large and heterogeneous datasets.

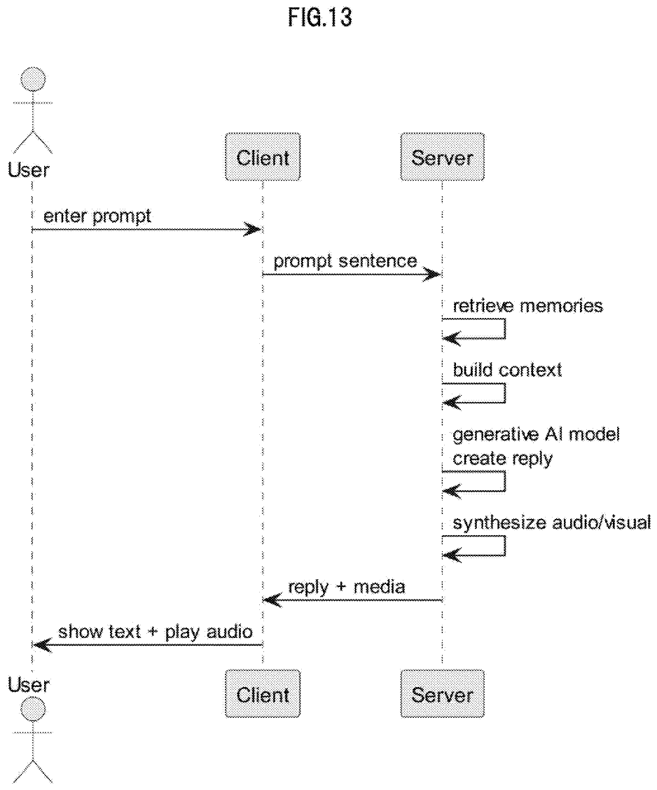

The following describes the processing flow using FIG. 13.

### Step 1:

Server acquires user-related information and group-related information from at least one external apparatus.

Server receives, as input, response messages that include metadata and content data such as image files, video files, audio files, and text records.

Server parses the response messages, extracts fields such as timestamps, identifiers, and media types, and writes the parsed records into a storage area as normalized temporal information, attribute information, and medium-type information.

Server outputs stored records, each associated with a unique identifier and linked binary content in object storage.

### Step 2:

Server executes media decoding and low-level preprocessing on stored multimedia content.

Server takes, as input, references to stored image files, video files, and audio files from the storage area.

Server decodes image files into pixel arrays, decodes video files into sequences of frames at predetermined frame rates, and decodes audio files into digital waveforms with normalized sampling rates and amplitudes.

Server outputs normalized image frames, normalized audio segments, and associated metadata suitable for subsequent feature extraction.

### Step 3:

Server performs feature extraction and recognition on visual information.

Server receives, as input, normalized image frames and metadata including temporal information and attribute information.

Server applies a convolutional neural network implemented in a machine learning framework to each frame to compute visual feature vectors representing face characteristics, scene characteristics, and object characteristics.

Server additionally applies recognition algorithms to detect faces, identify scene categories, and classify objects, and outputs feature vectors and recognition labels linked to the original visual records.

### Step 4:

Server performs feature extraction and recognition on audio information.

Server receives, as input, normalized audio segments and associated metadata.

Server segments the waveform using silence detection, applies speaker embedding models to derive speaker feature vectors, and computes prosodic features such as pitch contours, energy trajectories, and speech rate.

Server also invokes a speech recognition engine to convert speech segments into text transcripts with timestamps, and outputs audio feature vectors, speaker labels, and character information mapped back to the corresponding audio records.

### Step 5:

Server performs natural language processing on character information.

Server receives, as input, original text records and speech recognition transcripts, together with temporal and attribute metadata.

Server tokenizes the text, detects the language, and computes lexical feature quantities, emotional feature quantities, and topic feature quantities using natural language models.

Server outputs structured records containing tokenized text, sentiment scores, topic embeddings, and other text-derived features associated with the underlying events.

### Step 6:

Server constructs composite memory records and a memory information set.

Server receives, as input, visual feature vectors, audio feature vectors, text feature vectors, and corresponding metadata.

Server groups records that share compatible temporal information and attribute information to form composite memories that represent specific events involving the user or associated group.

Server applies a summarization model to the aggregated text content of each event to generate a short descriptive summary, combines all modality-specific feature vectors into a unified memory vector, and outputs a memory information set consisting of composite memory records with summaries and unified vectors.

### Step 7:

Server constructs a personality characteristic information set for an assumed persona.

Server receives, as input, memory records associated with a designated individual or group identifier.

Server aggregates lexical features, emotional features, topic features, and prosodic features across the selected memories, computes statistics such as typical emotional distribution, preferred topics, and characteristic speech rate, and identifies frequently used expressions.

Server outputs a persona profile that constitutes a personality characteristic information set for the assumed persona.

### Step 8:

Server configures and trains or fine-tunes a generative AI model to form a persona model.

Server receives, as input, the memory information set and the personality characteristic information set for the assumed persona.

Server prepares training samples in which input sequences include persona instructions and memory summaries, and target sequences include expected utterances, and then applies a training algorithm on a transformer-based neural network using a loss function such as cross-entropy and a gradient-based optimizer.

Server outputs trained model parameters and associates them with the persona profile, thereby forming a persona model for subsequent inference.

### Step 9:

Terminal initializes an interaction session with the server.

Terminal receives, as input, user selection of an assumed persona and a request to start interaction.

Terminal establishes a secure communication channel with the server, transmits session metadata, and receives initial configuration data including persona identification and optional greeting text.

Terminal outputs a user interface that displays the persona avatar, a text input field, a microphone control, and an area for displaying dialogue text.

### Step 10:

User provides a prompt sentence through the terminal.

User inputs, as text or speech, a natural-language request such as “Mom, please tell me about our last Christmas together.” or “Mom, what did we do on my tenth birthday?”.

User confirms the input by activating a send control or by completing voice input.

User outputs the prompt sentence to the terminal application as user input.

### Step 11:

Terminal transmits the prompt sentence and session information to the server.

Terminal receives, as input, the user-entered prompt sentence and the current session identifier.

Terminal optionally converts speech to text when the user used voice input, packages the prompt sentence and metadata into a request message, and sends the message to the server via the established communication channel.

Terminal outputs a network request that contains the prompt sentence for server-side processing.

### Step 12:

Server encodes the prompt sentence and retrieves relevant memory information.

Server receives, as input, the prompt sentence and session identifier from the terminal.

Server normalizes the prompt sentence, computes a vector representation using a sentence embedding model, and compares this vector with memory vectors in the memory information set using a similarity metric such as cosine similarity.

Server selects memory records whose vectors satisfy a top-k or threshold condition, generates structured descriptions of these memories, and outputs a subset of memory information that is semantically related to the prompt sentence.

### Step 13:

Server constructs context information for the generative AI model.

Server receives, as input, the normalized prompt sentence, the selected memory summaries, the persona profile, and, optionally, a relevant portion of dialogue history.

Server assembles these elements into a structured text context that includes persona instructions, memory descriptions, previous dialogue excerpts, and the current prompt sentence.

Server outputs a tokenized context sequence that serves as input data for the persona model.

### Step 14:

Server generates dialogue text using the persona model.

Server receives, as input, the tokenized context sequence and the persona model parameters.

Server processes the sequence through the transformer layers, computes hidden representations and output token probability distributions at each decoding step, and selects output tokens according to a decoding strategy such as nucleus sampling with a configured temperature and top-p parameter.

Server concatenates the selected tokens into a natural-language response that adopts the assumed persona's speaking style and refers to the retrieved memories, and outputs the resulting dialogue text.

### Step 15:

Server synthesizes audio data and visual display control data from the dialogue text.

Server receives, as input, the generated dialogue text and the persona profile including voice and expression parameters.

Server invokes a text-to-speech engine to convert the dialogue text into a digital audio waveform using voice characteristics associated with the assumed persona, and computes visual control parameters such as viseme sequences and facial expression values based on phoneme timing and emotional markers.

Server outputs audio data and visual display control data linked to the session and the dialogue text.

### Step 16:

Server transmits dialogue text, audio data, and visual display control data to the terminal.

Server receives, as input, the session identifier and the generated multimedia data.

Server packages the dialogue text, audio data, and visual control data into response messages and streams them to the terminal via the communication channel, and logs the prompt sentence and the dialogue text in the dialogue history within the storage area.

Server outputs network responses containing all elements needed for presentation at the terminal.

### Step 17:

Terminal presents the virtual reunion response to the user.

Terminal receives, as input, the dialogue text, audio data, and visual display control data from the server.

Terminal buffers the audio data for playback, applies the visual control data to the avatar rendering engine to animate mouth movements and facial expressions, and displays the dialogue text as subtitles or chat bubbles on the screen.

Terminal outputs synchronized audio and visual content, enabling the user to experience the assumed persona's response.

### Step 18:

User observes the response and optionally continues the conversation with additional prompt sentences.

User receives, as input, the audible speech and visual presentation provided by the terminal.

User evaluates the response, recalls associated memories, and decides whether to ask follow-up questions such as “Mom, what gift did you give me that Christmas?” or “Mom, how did you feel that day?”.

User outputs new prompt sentences to the terminal, thereby initiating subsequent cycles of retrieval and generation based on the established dialogue history.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems for recreating memories and virtual interactions with a person related to a user typically treat uploaded multimedia data as static content. Such systems generally present photos, videos, or pre-scripted messages without deeply integrating heterogeneous data types or adapting interaction in real time based on the user's emotional state. As a result, these systems have several technical limitations.

First, existing architectures often process images, audio, and text in isolated pipelines, lacking a unified feature representation that can be effectively consumed by a generative AI model. This fragmented processing leads to inefficient use of computational resources, redundant data handling, and limited personalization because the generative AI model cannot exploit the full contextual richness of the user-related digital information.

Second, conventional dialogue systems with virtual characters or chatbots typically rely on static prompts or fixed rules. They do not dynamically reconstruct prompt sentences for a generative AI model based on changing user context, including dialogue history, ongoing user behavior, and real-time emotion signals. Consequently, the generated responses are often generic, repetitive, and weakly coupled to the specific memory scenario, which results in low immersion and limited user engagement.

Third, virtual reality and three-dimensional environments are frequently generated as generic scenes without being tightly synchronized with persona behavior and emotional adaptation. The virtual environment engine and the dialogue engine are usually loosely coupled, so updates in user emotion or behavior do not systematically propagate to either the three-dimensional environment or the generative AI model input. This decoupling causes inconsistency between what the user sees in the virtual scene and how the virtual persona behaves, thereby degrading the quality and realism of the interactive experience.

Fourth, many systems do not treat the virtual reunion as a user-specific narrative that evolves over time based on user actions and feelings. They lack a mechanism that incrementally updates both the internal persona profile and the three-dimensional virtual environment information as a function of real-time user emotion and interaction history. From a computer-technology perspective, this means there is no integrated control loop that continuously reconfigures the generative AI model's prompt sentences and the rendered environment, leading to a static, non-adaptive system behavior.

Accordingly, there is a need for an improved computer-implemented system that (i) unifies heterogeneous user-related digital information into integrated memory information, (ii) programmatically constructs and updates prompt sentences for a generative AI model based on persona profiles, dialogue history, and real-time emotion analysis, and (iii) tightly couples dialogue generation with three-dimensional virtual environment generation such that both are jointly and dynamically adapted to the user's behavior and emotional state. By solving these technical problems, the system can improve the operation of computers in the fields of dialogue generation, emotion-aware interaction, and virtual environment rendering, providing more contextually consistent and computationally efficient virtual reunion experiences.

The specific processing by the specific processing unit 290 of the data processing device 12 in Application Example 2 is realized by the following means.

The present invention provides a server comprising a processor and a communication interface, the processor being configured to acquire, via the communication interface, a group of digital information items related to a user, to classify the group of digital information items by type, to perform preprocessing for each type, to extract feature values from the group of digital information items, and to integrate the feature values as memory information; to generate, on the basis of the integrated memory information, a prompt sentence to be input to a generative AI model for dialogue generation, to input the prompt sentence to the generative AI model, and to generate, as an output from the generative AI model, an assumed persona profile including characteristic information and dialogue policy information of a virtual persona related to the user; to acquire voice information and image information of the user during interaction, to estimate an emotional state of the user by using an emotion analysis model on the basis of the voice information and the image information, to add the emotional state as a dialogue generation condition to the assumed persona profile, and to dynamically update the prompt sentence to be input to the generative AI model in accordance with the emotional state; to generate, on the basis of the assumed persona profile, utterance content of the user, the emotional state of the user, and dialogue history, a further prompt sentence to be input to the generative AI model, and to output, as a dialogue from the virtual persona, a response sentence acquired from the generative AI model; and to generate, on the basis of the group of digital information items and the assumed persona profile, three-dimensional virtual environment information simulating a past experience scene, to provide the three-dimensional virtual environment information to an output device so as to present to the user a virtual reunion scene with the virtual persona, and to update, during presentation of the virtual reunion scene, the prompt sentence and the three-dimensional virtual environment information in accordance with behavior information and the emotional state of the user acquired during the presentation so as to sequentially change the virtual reunion scene as a personal experience story of the user. This enables integrated and adaptive control of generative AI dialogue and three-dimensional virtual environment rendering based on unified memory information and real-time emotion analysis, thereby improving computer operation by producing contextually consistent, emotion-aware virtual reunion experiences that efficiently utilize heterogeneous user-related data.

The term “system” refers to a combination of hardware and software components including at least one processor, memory, communication interfaces, and output devices that cooperate to execute the claimed processing.

The term “processor” refers to one or more hardware processing units, such as a central processing unit or a graphics processing unit, that execute machine-readable instructions to perform data processing operations.

The term “communication interface” refers to a hardware and software interface configured to transmit and receive data between the system and external devices or networks, including wired and wireless interfaces.

The term “digital information item” refers to any data representing content related to a user in a digital form, including at least one of still images, moving images, audio recordings, text data, and metadata.

The term “group of digital information items” refers to a plurality of digital information items associated with a particular user, session, or scenario, which are processed collectively by the processor.

The term “classify by type” refers to an operation of categorizing digital information items according to their data format or modality, such as image, video, audio, or text. The term “preprocessing” refers to a set of operations performed on raw digital information items to convert them into a normalized or analysis-ready form, including at least one of resizing, normalization, noise reduction, feature extraction, or tokenization.

The term “feature value” refers to a numerical or symbolic representation extracted from a digital information item that characterizes properties of the item, such as visual features from images, acoustic features from audio, or linguistic features from text.

The term “memory information” refers to integrated data obtained by aggregating feature values extracted from multiple digital information items, representing past experiences or characteristics associated with a user or a related person.

The term “generative AI model” refers to a machine learning model configured to generate output data, such as text, conditioned on input data, wherein the model has been trained using large-scale data and can produce context-dependent responses.

The term “prompt sentence” refers to a structured input sequence provided to a generative AI model, including instructions, context information, and sample data, which guides the generative AI model to generate desired output.

The term “assumed persona profile” refers to structured data representing a virtual persona related to a user, including characteristic information such as personality traits, speaking style, and preferences, and dialogue policy information such as response strategies.

The term “virtual persona” refers to a computer-generated agent that simulates characteristics, speech patterns, and behaviors of a real or imagined person, and that interacts with a user through generated dialogue.

The term “characteristic information” refers to data describing attributes of a virtual persona, including at least one of personality traits, emotional tone, typical expressions, and relationships to the user.

The term “dialogue policy information” refers to rules or parameters defining how a virtual persona should respond in conversation, including tone, length, level of detail, and adaptation to user context.

The term “voice information” refers to audio data capturing vocal sounds of the user, including spoken utterances and paralinguistic features such as intonation and volume.

The term “image information” refers to visual data capturing the appearance or behavior of the user, including still images and video frames.

The term “emotion analysis model” refers to a computational model configured to estimate an emotional state of a user based on input data such as voice information or image information.

The term “emotional state” refers to an inferred condition representing a user's affect, such as happiness, sadness, anger, or calmness, which may be expressed as categorical labels, continuous values, or multidimensional vectors.

The term “dialogue generation condition” refers to contextual parameters provided to a generative AI model that influence the content and style of generated dialogue, including emotional state, scenario context, and persona constraints.

The term “dialogue history” refers to stored data representing previous exchanges between the user and the virtual persona, including user utterances and generated responses.

The term “response sentence” refers to a natural-language text output generated by the generative AI model and presented to the user as a message from the virtual persona.

The term “three-dimensional virtual environment information” refers to data that defines a spatially represented digital scene, including geometry, textures, lighting, object attributes, and positions, suitable for rendering a three-dimensional environment.

The term “past experience scene” refers to a virtual representation of a situation or environment that corresponds to or is derived from events experienced by the user or a related person in the past.

The term “output device” refers to any hardware configured to present information to a user, including at least one of a display, a head-mounted display, speakers, or a haptic device.

The term “virtual reunion scene” refers to a rendered three-dimensional environment in which a user can perceive and interact with a virtual persona as if reuniting with a real person in a reconstructed or simulated past context.

The term “behavior information” refers to data representing user actions during interaction with the system, including at least one of gaze direction, gestures, selection operations, movement, and input events.

The term “personal experience story” refers to a sequence of system states and interactions that collectively form a narrative specific to an individual user, determined by the user's data, behavior, and emotional state over time.

The term “data linkage mechanism” refers to a combination of protocols and interfaces that enable the system to retrieve or exchange data with an external storage apparatus or an external service, including application programming interfaces and data transfer procedures.

The term “external storage apparatus” refers to a data storage system located outside the main system, such as a network-attached storage device or a cloud-based storage service.

The term “external service” refers to a remote computing or data-provision service accessible over a network, which supplies digital information items or processing results to the system.

The term “storage apparatus” refers to any device or subsystem configured to store digital data, including volatile memory, non-volatile memory, or mass storage.

The term “selection operation” refers to an input action performed by a user to choose among options presented by the system, including pointer operations, touch operations, button presses, or controller inputs.

The term “utterance content” refers to the semantic and linguistic content of a user's spoken or written message provided during interaction with the system.

The term “narrative structure” refers to an organization of events, scenes, and dialogues into a sequence that reflects a storyline, including beginnings, developments, and outcomes, which can differ between users.

In one embodiment, a server, a terminal, and a user cooperate to implement the claimed system. The server includes at least one hardware processor, a main memory, a non-volatile storage device, and a network interface card connected to a packet-switched network. The terminal includes at least one processor, a memory, a display device, an audio output device, a camera, and a microphone. The user operates the terminal to provide digital information items and to experience a virtual reunion scene presented by the terminal based on processing performed by the server.

The server executes a set of software modules stored in the non-volatile storage device and loaded into the main memory. These modules include, for example, an HTTP/HTTPS communication module, a multimedia preprocessing module, a feature extraction module, a memory integration module, a prompt construction module, a generative AI interface module, an emotion analysis module, a dialogue management module, and a three-dimensional environment generation module. The server can execute these modules under control of an operating system, using general-purpose processors or specialized accelerators such as graphics processing units. The terminal executes an application that provides a graphical user interface for uploading digital information items and for viewing a three-dimensional virtual environment. The terminal may use a game engine such as a three-dimensional rendering engine to render three-dimensional virtual environment information received from the server. The terminal may also execute a lightweight emotion capture module that controls acquisition of image information from the camera and voice information from the microphone and transfers such information to the server. In one implementation, the server is configured to receive a group of digital information items related to a user via the communication interface. The user operates the terminal to select still images, moving images, audio recordings, text data, and other digital information items stored locally or in a remote storage service. The terminal transmits the selected digital information items using an application-layer protocol such as HTTP over a transport-layer protocol such as TLS to ensure secure transport. The server receives the data streams, verifies integrity using checksums, and writes the raw byte sequences to the storage device. The server creates metadata records in a relational datastore or a document datastore, linking each digital information item to a user identifier and to a session identifier.

The server classifies the group of digital information items by type. The multimedia preprocessing module reads the header or container information of each digital information item and determines a data type such as image, video, audio, or text. The server writes the classification result as type fields in the metadata records. This explicit classification allows the server to dispatch each digital information item to a type-specific preprocessing pipeline, which improves computation efficiency by avoiding unnecessary processing steps.

For images and video frames, the server uses an image processing library such as a computer vision library to decode encoded pixel data into a matrix representation. The server resizes images to a standard resolution, such as 256×256 or 512×512 pixels, and normalizes pixel intensities to a floating-point range required by subsequent neural network models. The server applies a convolutional neural network-based face detector and, optionally, a scene classifier to each image or sampled video frame. The server stores face bounding boxes as coordinate tuples and extracts feature vectors using a pre-trained convolutional neural network backbone. The server writes these feature vectors into a feature store associated with the session.

For audio recordings, the server uses an audio processing library to resample audio signals to a unified sampling rate, such as 16 kHz, and to convert stereo signals to mono signals. The server computes short-time Fourier transforms and derives mel-frequency cepstral coefficients and related acoustic descriptors. The server inputs these descriptors into a recurrent or transformer-based acoustic style model that has been trained to estimate voice characteristics such as typical pitch range, speech rate, and energy contour patterns. The server stores the model outputs as feature values associated with the original audio recordings.

For text data, the server uses a natural language processing toolkit to perform tokenization, sentence segmentation, part-of-speech tagging, and named entity recognition. The server extracts entities such as locations, dates, and person names, and also computes sentiment scores and stylistic descriptors such as formality level and use of specific phrases. The server stores sparse or dense representations such as bag-of-words vectors or transformer-based embeddings in the feature store.

The server integrates the feature values extracted from different modalities into memory information. To achieve this, the server uses a predefined data structure that associates each memory unit with fields such as time stamp, location estimate, participants, and affective tone. The server performs clustering on visual and textual features to group digital information items that refer to similar scenes or events. The server associates recurring faces with a main target person based on user labels or frequency counts. As a result, the server produces a structured representation of the user's past experiences and related persons, which is stored as integrated memory information in the storage device.

On the basis of the integrated memory information, the server constructs a prompt sentence to be input to a generative AI model for dialogue generation. The generative AI model may be implemented as a transformer-based language model having multiple attention layers, position encodings, and learned token embeddings. The server does not alter the internal weights of such a model during runtime; instead, the server shapes the output behavior by constructing a prompt sentence that encodes instructions and context.

The server generates a base persona description by aggregating features such as typical sentiment, common phrases, and topics of interest from the memory information. The prompt construction module concatenates a system instruction segment, a persona background segment, a style specification segment, and a few example utterances extracted from the text data. For example, the server may construct a prompt sentence such as:

“You are a generative AI model that constructs a conversational persona. Based on the following trait profile and example texts, generate a detailed persona description that imitates the speaking style, emotional tone, and relationship to the user. Trait profile: warm, gentle, frequently says ‘I'm proud of you’, enjoys going to cafés with the user. Example messages: ‘I'm so proud of you’, ‘Let's go to the café again next week.’ Please output a structured persona specification with sections: Background, Personality, Speaking Style, Typical Phrases, and Guidelines for interacting with the user.”

The server supplies this prompt sentence as a sequence of tokens to the generative AI model through the generative AI interface module. The generative AI model, which has been pre-trained using large-scale text corpora and optionally fine-tuned on dialogue data, produces a text output representing an assumed persona profile. The server parses this text output into structured fields, such as a background description, personality characteristics, and dialogue policy information.

The server stores the assumed persona profile. This profile functions as a high-level controller for later prompt construction. Reusing the profile avoids re-deriving the persona traits for each dialogue turn, which reduces computation and improves response latency.

The server further acquires voice information and image information of the user during interaction. The terminal captures video frames of the user's face by operating the camera at a predetermined frame rate and records audio signals of the user's speech through the microphone. The terminal compresses and transmits the captured data via the network to the server in short segments.

The server uses an emotion analysis model to estimate an emotional state of the user based on the received voice information and image information. In one embodiment, the emotion analysis model includes a first neural network that processes facial images and a second neural network that processes acoustic features. The first neural network may be implemented as a convolutional neural network that outputs probabilities for categories such as happiness, sadness, anger, and neutrality. The second neural network may be implemented as a recurrent or transformer-based network that processes sequences of acoustic feature vectors and outputs continuous arousal and valence scores. The server combines the outputs from both networks via a weighting scheme or a shallow fusion network to obtain a final emotional state vector. The server writes the emotional state vector into the session state in memory.

The server adds the emotional state as a dialogue generation condition to the assumed persona profile. Specifically, the prompt construction module appends one or more sentences describing the current emotional state and required adaptation rules to the prompt sentence for the generative AI model. This explicit encoding of emotion improves technical performance because it allows the generative AI model to use its internal conditional generation mechanisms to produce responses that are more consistent with the user's current affect, thus reducing the need for additional post-processing or rule-based adjustments.

The server dynamically updates the prompt sentence to be input to the generative AI model in accordance with the emotional state. For each dialogue turn, the server retrieves the latest emotional state vector, the last few user utterances, and the assumed persona profile. The server composes a new prompt sentence such as:

“You are controlling the persona of the user's mother. Background: gentle, supportive, often encourages the user. The user currently appears sad according to emotion analysis. Recent conversation: the user said, ‘I wish we had more time together.’ Respond as the mother in a warm, comforting tone, acknowledge the sadness, recall a positive shared memory, and encourage the user. Keep the reply between 3 and 6 sentences.”

This dynamic prompt construction technique differs from simple static prompts in that the server explicitly encodes time-varying signals such as emotion and dialogue history into the prompt. This structure reduces ambiguity for the generative AI model, thereby improving response accuracy and reducing token consumption, which contributes to computational efficiency and lower communication load.

The server generates, based on the assumed persona profile, user utterance content, emotional state, and dialogue history, a further prompt sentence and receives a response sentence from the generative AI model. The server may use beam search or nucleus sampling parameters to control the diversity and determinism of the generated response. The server stores the response sentence as part of the dialogue history, together with timestamps and emotional state values, forming a structured log that can be reused for future context summarization.

The server also generates three-dimensional virtual environment information simulating a past experience scene. The server uses the integrated memory information and the assumed persona profile to select a target scene, such as a café or a family living room, that is relevant to the user. The server derives scene attributes such as approximate layout, dominant objects, lighting conditions, and ambient sounds from visual and textual features. The three-dimensional environment generation module converts these attributes into a scene specification that includes object identifiers, positions, orientations, and material parameters.

The terminal receives the three-dimensional virtual environment information and uses a three-dimensional rendering engine to instantiate the specified objects and render the scene to the display or a head-mounted display. The terminal may also animate an avatar representing the virtual persona, positioning the avatar at a location such as a seat opposite the user's viewpoint. The server sends timing and content information for the response sentences, and the terminal synchronizes mouth movement or other animations of the avatar to match the audio output or displayed text.

The server updates, during presentation of the virtual reunion scene, the prompt sentence and the three-dimensional virtual environment information in accordance with behavior information and emotional state of the user. The terminal transmits behavior information representing gaze direction, selection operations, or navigation events in the three-dimensional scene to the server. For example, if the user looks at a particular object such as a window seat or a family photograph, the server can detect this event and modify the next prompt sentence to cause the virtual persona to refer to that object. This closed-loop coupling between user behavior, prompt construction, and environment content enables the system to produce a narrative that responds to the user's focus of attention, thereby increasing immersion and making more efficient use of the generative AI model.

From a computer-technology perspective, this architecture improves performance in several ways. By classifying and preprocessing digital information items into standardized features and memory information, the server reduces redundant computations and storage overhead. By constructing structured, context-rich prompt sentences instead of sending raw or loosely organized data to the generative AI model, the server reduces the number of tokens required and thereby decreases network transmission volume and inference time. By explicitly incorporating an emotional state vector and behavior information into prompt construction, the server allows the generative AI model to generate more accurate and appropriate responses, which decreases the need for corrective logic and lowers the rate of inconsistent outputs.

Moreover, the emotion analysis model and the integration of multi-modal features represent more than simple automation of human judgment. The server uses neural network architectures that combine convolutional, recurrent, and attention-based layers, trained with supervised and self-supervised learning. For example, the server can train the emotion analysis model using a cross-entropy loss for categorical emotion labels and a mean squared error loss for continuous arousal and valence values, updating network weights by stochastic gradient descent with adaptive learning rates. The server can augment training data with transformations such as random cropping, time stretching, and noise injection to improve robustness. These design choices contribute to higher accuracy and stability in emotional state estimation, which directly influences the quality and technical performance of the dialogue generation pipeline.

The system also improves data management. The server uses explicit data structures for memory information and persona profiles, enabling efficient indexing and retrieval of relevant past experiences. When constructing a scenario, the server can perform vector similarity searches over feature embeddings to find the most relevant images or messages. This targeted retrieval reduces the amount of data that must be processed for each scene and allows the system to scale to large user archives without proportional increases in latency.

The server's prompt construction strategy follows non-conventional rules tailored to the generative AI model. Rather than simply concatenating all context, the server selects and summarizes relevant parts of the dialogue history and memory information, enforces explicit sections such as “Background,” “Current scene,” and “User emotion,” and uses imperative instructions directing the model's behavior. This structured approach can be seen as a specialized protocol between the server and the generative AI model that enhances determinism and reproducibility of persona behavior. As a result, the system achieves more consistent persona responses across sessions, which is beneficial when the system is used in long-term applications. In a further embodiment, the server may deploy the generative AI model locally or access it as a remote service. If the model is deployed locally, the server may use a model quantization procedure and batch the processing of multiple prompt sentences to reduce computational load and improve throughput. If the model is accessed remotely, the server may aggregate multiple interactions into a single request when possible, reducing the number of network round trips and thus lowering communication latency and bandwidth usage.

In another embodiment, the server may vary the architecture of the emotion analysis model. For example, the server may use a multi-head attention network over temporal segments of facial features and acoustic features, using a joint loss function that encourages consistency between modalities. This design can further reduce misclassification of emotional states, which directly enhances the appropriateness of generated responses and improves user experience. The system is not limited to a particular type of display device. The terminal may be implemented as a smartphone, a tablet, a head-mounted display, or a desktop computer. When the terminal is a head-mounted display, the three-dimensional virtual environment information may include stereoscopic rendering parameters and head tracking configurations, enabling low-latency updates of the virtual scene in response to user head motion. This integration demonstrates that the claimed system is connected to and controls physical rendering hardware in a way that goes beyond abstract data manipulation.

In another variation, the server may generate multiple candidate virtual environments for a given memory and select one based on estimated network conditions or device capabilities received from the terminal. For example, when bandwidth is limited, the server may choose a lower-complexity scene description with fewer objects and lower-resolution textures. This adaptive scene selection reduces communication load and maintains acceptable frame rates, representing a technical optimization of resource usage.

The user experiences the system by engaging in an interactive virtual reunion with a virtual persona that responds in real time and in a manner consistent with the user's memories and emotional state. The user's operations, such as selecting scenarios, speaking, and gazing at objects, influence the behavior of the generative AI model and the configuration of the virtual environment through explicit data pathways and control logic in the server. Because of the architecture described above, the system performs complex, multi-modal data processing and real-time model interaction that is not feasible to perform accurately and efficiently through manual human operations.

Thus, by providing specific data structures (memory information, assumed persona profiles, three-dimensional virtual environment information), by constructing and updating specialized prompt sentences for a generative AI model, by using a multi-modal emotion analysis model, and by tightly coupling dialogue generation with three-dimensional rendering behavior, the server, the terminal, and the user collectively realize an implementation that improves computer operation in terms of accuracy, latency, resource usage, and contextual consistency. These improvements arise from concrete technical features and processing flows rather than from mere automation of human mental steps.

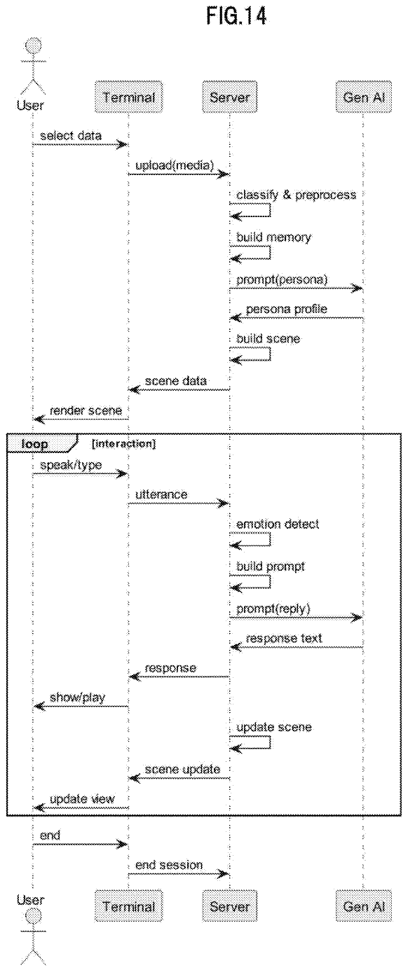

The following describes the processing flow using FIG. 14.

### Step 1:

The user operates the terminal to select digital information items. The user chooses images, videos, audio recordings, and text messages stored on local storage or in a remote storage service, and confirms an upload operation through a graphical user interface. The input is a user selection of file paths or resource identifiers. The terminal converts these selections into a list of file descriptors. The output is a prepared upload request that associates each digital information item with a user identifier and a session identifier.

### Step 2:

The terminal transmits the selected digital information items to the server. The terminal encapsulates the binary data of each file and metadata (file name, type, size, timestamps) into a structured network message, for example, an HTTP request with multipart/form-data. The input is the list of file descriptors and the actual file contents. The terminal performs data serialization and initiates secure communication using a transport protocol. The output is a sequence of network packets carrying the group of digital information items to the server.

### Step 3:

The server receives and stores the group of digital information items. The server's communication interface accepts the incoming network packets and reconstructs the payloads into the original file contents and metadata. The input is the transmitted binary streams and HTTP headers. The server verifies checksums, validates file types, and writes the raw files into a storage apparatus, such as a file system or object store, while creating metadata records in a database that map each file to the user identifier and session identifier. The output is a persistent dataset consisting of raw digital information items and corresponding metadata entries.

### Step 4:

The server classifies the digital information items by type. The server reads each metadata record and, if needed, inspects the file header to determine whether the item is an image, video, audio, or text. The input is the metadata table and file headers. The server performs a lookup of MIME types and file extensions and assigns a type label to each item. The output is an updated metadata table in which each digital information item has an explicit type field used for routing to type-specific pipelines.

### Step 5:

The server preprocesses image and video data. The server loads image files and sampled frames from video files into memory. The input is a set of image-type and video-type digital information items. The server decodes compressed image formats, resizes them to a standard resolution, normalizes pixel values, and applies a convolutional neural network-based model to detect faces and extract visual feature vectors. The data processing includes matrix operations, convolution, pooling, and non-linear activations. The output is a set of visual feature values and face bounding boxes associated with each processed image or video frame.

### Step 6:

The server preprocesses audio data. The server reads audio-type digital information items from storage. The input is a set of audio files containing user-related speech or sounds. The server resamples audio waveforms to a unified sampling rate, converts stereo to mono, and computes time-frequency representations such as spectrograms and mel-frequency cepstral coefficients. The server then passes these feature matrices through an acoustic analysis model, for example, a recurrent neural network, to derive voice style descriptors such as typical pitch range and speaking rate. The output is a set of acoustic feature values and style descriptors linked to each audio recording.

### Step 7:

The server preprocesses text data. The server retrieves text-type digital information items such as messages or transcripts. The input is a collection of text strings. The server tokenizes the text into words or subword units, segments sentences, performs part-of-speech tagging, and identifies named entities such as person names and locations using a natural language processing toolkit. The server also computes sentiment scores and extracts frequently used phrases. The output is a structured representation of each text item, including tokens, entities, sentiment values, and stylistic indicators.

### Step 8:

The server integrates multi-modal feature values into memory information. The server aggregates visual, acoustic, and textual feature values across all digital information items for the session. The input is the collections of feature values produced in Steps 5-7 and the metadata records linking items to times and contexts. The server performs clustering and association operations to group items that refer to similar scenes or events and to associate recurring faces and names with specific persons. The server then constructs memory units, each represented by a data structure containing time, location estimates, participants, and affective tone. The output is integrated memory information stored as session-specific records.

### Step 9:

The server derives trait information for a virtual persona. The server analyzes the memory information to identify patterns corresponding to a person related to the user, such as a family member. The input is the integrated memory information and user-provided labels indicating a target person. The server computes statistics such as common topics, typical sentiment, frequently used expressions, and behavioral cues from audio and text. The server aggregates these statistics to form a trait profile describing personality, speaking style, and emotional tone. The output is a structured trait profile that characterizes the virtual persona.

### Step 10:

The server constructs an initial prompt sentence for persona generation. The server uses the trait profile and selected example texts to build a textual instruction for a generative AI model. The input is the trait profile, a set of representative user-related messages, and predefined prompt templates. The server concatenates a system instruction segment, a background description, a style specification, and example utterances into a coherent prompt sentence. The data processing includes string formatting, token selection, and ordering according to a template. The output is a prompt sentence designed to cause the generative AI model to output an assumed persona profile.

### Step 11:

The server generates an assumed persona profile using the generative AI model. The server sends the prompt sentence to the generative AI model through an interface that converts text into token sequences. The input is the prompt sentence from Step 10. The generative AI model, implemented for example as a transformer network, applies attention-based operations to compute a probability distribution over next tokens and produces a text description of a persona. The server receives this text, parses it to extract sections such as background and speaking style, and stores the result in a structured format. The output is an assumed persona profile containing characteristic information and dialogue policy information.

### Step 12:

The server selects and prepares a scenario based on memory information. The server identifies one or more significant past experience scenes, such as a café visit or a trip, from the memory information. The input is the integrated memory information and, optionally, user input specifying a preferred scenario. The server performs a search over memory units using indicators such as location tags and affective tone, selects a scenario, and summarizes its key attributes. The output is a scenario specification that describes a target past experience scene, including semantic labels for objects, places, and emotional context.

### Step 13:

The server generates three-dimensional virtual environment information. The server converts the scenario specification into a scene description suitable for a three-dimensional engine. The input is the scenario specification from Step 12. The server maps semantic elements such as “café table,” “window seat,” and “afternoon light” to object identifiers, positions, and lighting parameters. The server arranges objects in a virtual coordinate system and defines materials and textures. The output is three-dimensional virtual environment information including geometry data, object placement, and rendering parameters.

### Step 14:

The terminal renders the three-dimensional virtual environment. The terminal receives the three-dimensional virtual environment information from the server. The input is the scene description with object data and camera parameters. The terminal loads corresponding 3D assets, initializes a camera viewpoint, and executes rendering operations using a graphics engine. The terminal outputs a real-time visual presentation on a display or head-mounted display. The output is a rendered virtual reunion scene presented to the user.

### Step 15:

The terminal acquires real-time user behavior and emotion-related data. The terminal controls the camera to capture images or video of the user and the microphone to capture voice audio while the user is in the virtual scene. The input is physical sensor signals from the camera and microphone. The terminal digitizes these signals, compresses them if necessary, and forwards them to the server together with interaction events such as gaze targets or selection operations. The output is a stream of user behavior information and raw emotion-related data sent to the server.

### Step 16:

The server estimates the user's emotional state. The server receives the user's image and audio data, as well as behavior information. The input is the streams from Step 15. The server applies an emotion analysis model that processes facial images and acoustic features to infer emotion categories or continuous emotion values. The processing includes convolutional operations on images, sequential modeling on audio features, and fusion of modality-specific outputs. The output is an emotional state vector that represents the user's current affective condition.

### Step 17:

The user provides an utterance to the virtual persona. The user speaks or types a message while observing the virtual scene. The input is the user's conscious decision to express a question or statement. The terminal captures spoken audio through the microphone or text through the user interface. The output is a digital representation of a user utterance that the terminal can send to the server.

### Step 18:

The server converts spoken utterances into text, if necessary. The server receives the audio stream of the user's speech from the terminal. The input is the user's speech signal. The server applies a speech recognition model to segment the audio and map acoustic patterns to words using statistical or neural network decoding. The output is a text transcription of the user's utterance.

### Step 19:

The server constructs a dialogue-specific prompt sentence for the generative AI model. The server takes as input the assumed persona profile, the emotional state vector, the dialogue history, and the user's latest utterance in text form. The server summarizes recent exchanges, encodes the emotional state into descriptive language, and inserts these as context into a prompt template. The data processing involves string concatenation, selection of salient past utterances, and insertion of persona-specific instructions. The output is a dialogue-specific prompt sentence that instructs the generative AI model how the virtual persona should respond in the current context.

### Step 20:

The server generates a response sentence using the generative AI model. The server submits the dialogue-specific prompt sentence to the generative AI model. The input is the prompt sentence from Step 19. The generative AI model computes token probabilities and generates a response text that imitates the virtual persona's style and accounts for the user's emotional state. The server may constrain generation parameters such as temperature and maximum length. The output is a response sentence representing the virtual persona's reply.

### Step 21:

The server records and optionally transforms the response sentence. The server appends the response sentence to the dialogue history together with a timestamp and the current emotional state. The input is the raw generated response from the generative AI model. The server may perform light post-processing, such as trimming whitespace or filtering disallowed content. The output is a finalized response sentence ready for presentation and a dialogue history entry stored for future context.

### Step 22:

The server sends the response sentence and any associated control data to the terminal. The server packages the response sentence, information about the persona's intended behavior (such as gestures or gaze direction), and timing data into a network message. The input is the processed response sentence and optional animation cues. The output is a structured response packet transmitted to the terminal.

### Step 23:

The terminal presents the virtual persona's response in the virtual scene. The terminal receives the response packet from the server. The input is the response sentence and behavioral cues. The terminal displays the response text as subtitles or chat bubbles and, if audio synthesis is used, plays a synthesized voice through speakers or headphones. The terminal also updates the avatar's posture, facial expressions, or gaze according to the cues. The output is a synchronized audiovisual presentation perceived by the user as a reply from the virtual persona.

### Step 24:

The server updates the virtual environment based on user behavior and emotion. The server monitors streamed behavior information (such as gaze on objects) and updated emotional states during ongoing interaction. The input is the continuous behavior and emotion data. The server modifies the three-dimensional virtual environment information, for example, by highlighting objects the user focuses on or transitioning to another scene when certain conditions are met. The server then transmits updated scene information to the terminal. The output is new environment parameters that cause the virtual scene to evolve in accordance with the user's actions and feelings.

### Step 25:

The user continues the interaction or terminates the session. The user decides whether to ask further questions, explore different memories, or end the virtual reunion. The input is the user's voluntary control actions, such as issuing a new utterance or selecting an exit option. The terminal interprets these actions and either initiates another cycle of Steps 15 through 24 or sends a termination signal to the server. The output is either continued dialogue and scene updates or a clean shutdown of the session state on the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

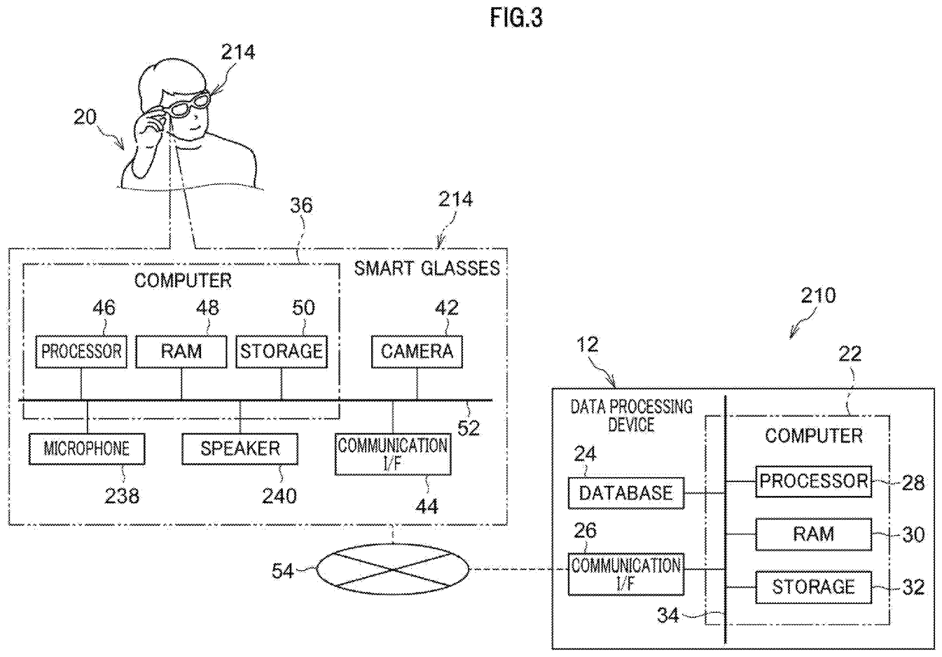

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

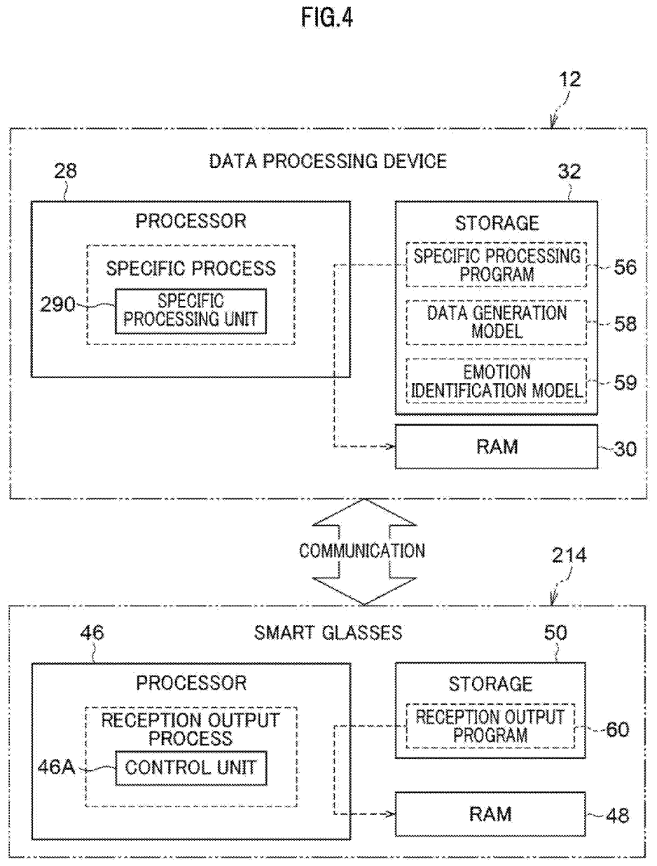

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

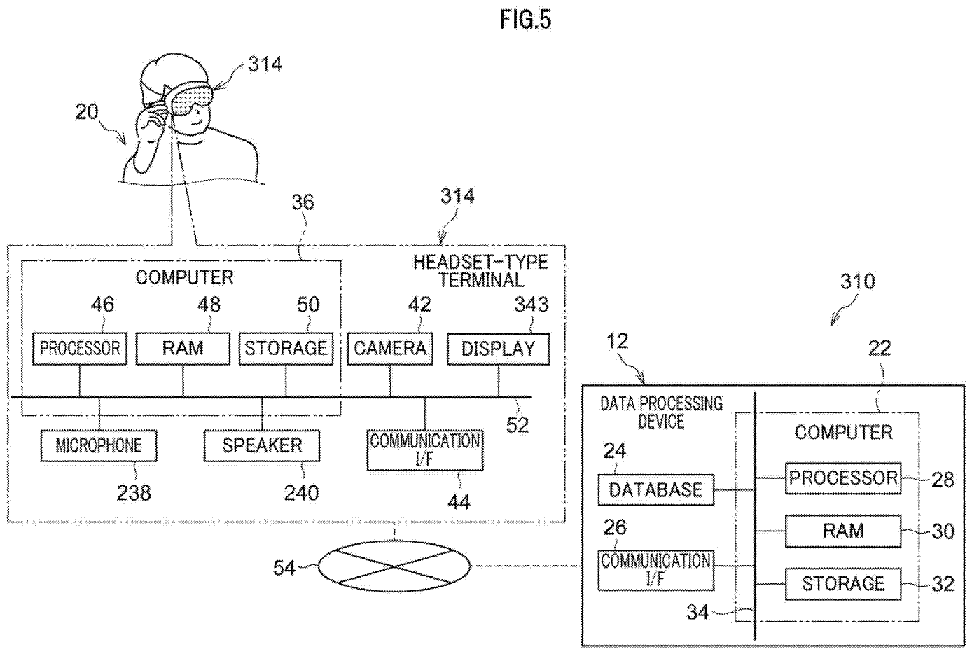

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

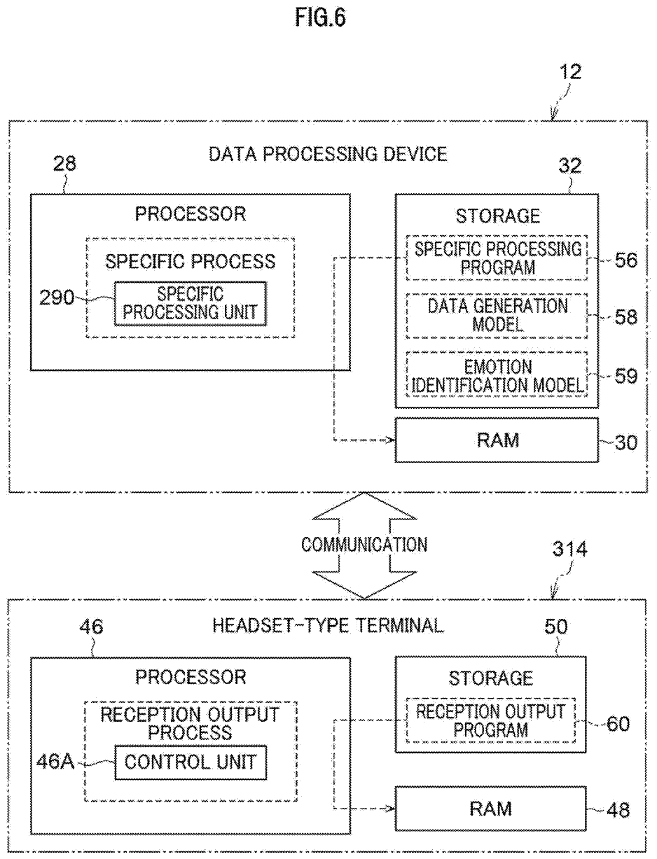

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

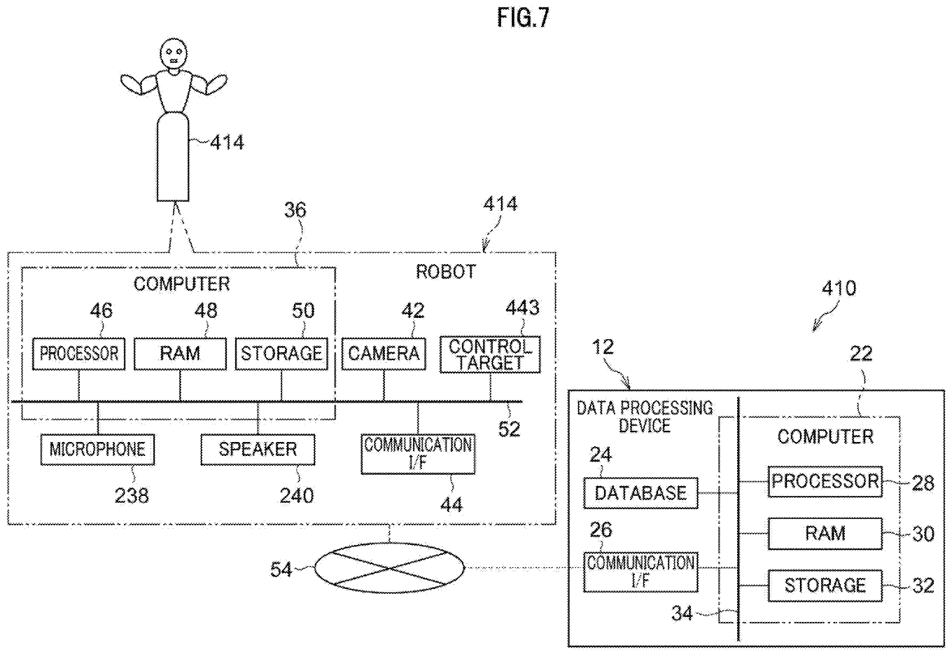

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

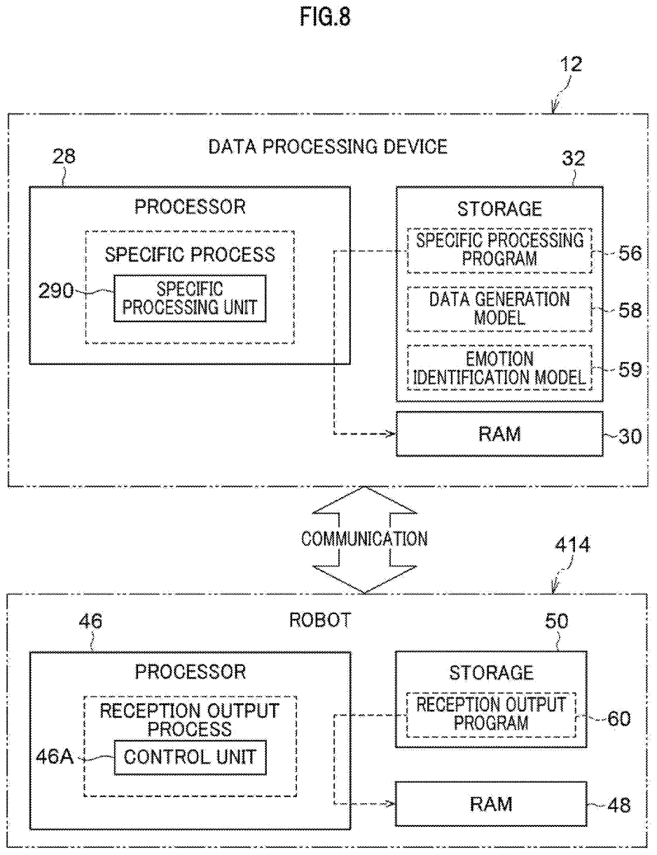

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

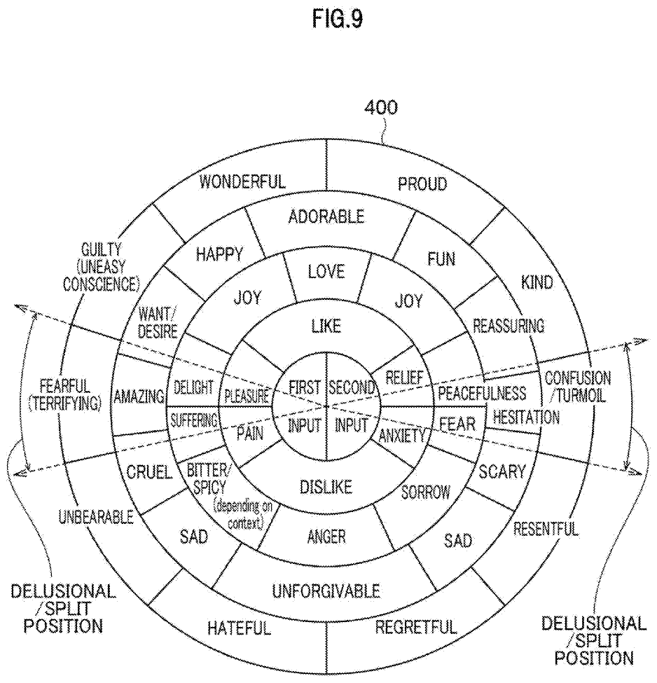

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

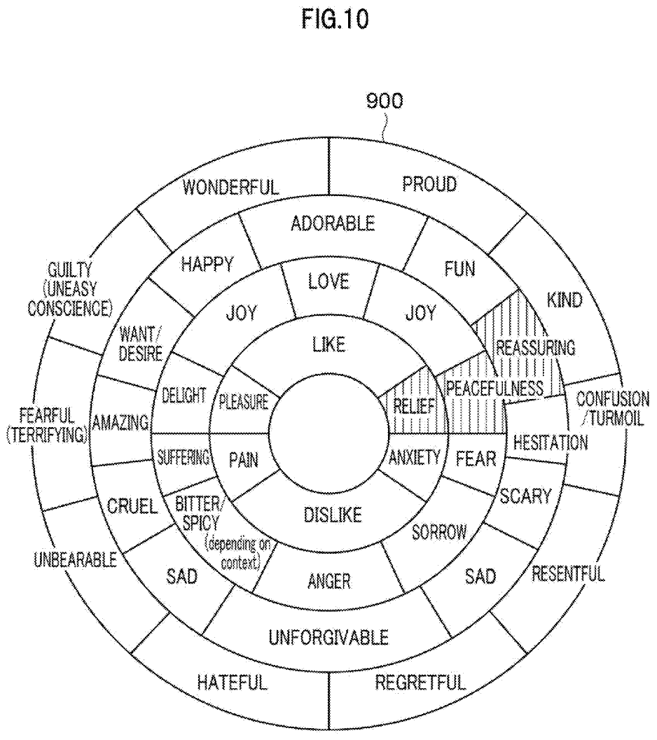

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a

CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire person-related information and group-related information as electronic information from an external information processing apparatus via a communication interface, store the electronic information in a storage device, and include, as the electronic information, image information, moving image information, audio information, character information, and posting information; and
perform preprocessing on the stored electronic information by using an information analysis function, execute language analysis processing on the character information and the audio information to extract expression tendency information and emotion tendency information, execute feature extraction processing on the image information and the moving image information to extract subject feature information and scene feature information, and generate personality information by integrating the extracted expression tendency information, emotion tendency information, subject feature information, and scene feature information; and
construct, on the basis of the personality information and the electronic information, a dialogue data processing model serving as an assumed personality by using a generative AI model, and store the dialogue data processing model as the assumed personality in the storage device; and generate description information for each memory element extracted from the electronic information, convert the description information into feature vectors by vectorization processing, and store the feature vectors as a memory index structure that is searchable by similarity; and receive, from an input device, a prompt sentence input by a user, convert the prompt sentence into a prompt feature vector by the vectorization processing, and execute similarity search on the memory index structure by using the prompt feature vector to specify memory elements related to the prompt sentence; and
generate integrated prompt information for the generative AI model by including dialogue control information corresponding to the assumed personality, context information based on the specified memory elements, and the prompt sentence as input information, input the integrated prompt information to the generative AI model, and cause the generative AI model to generate a response sentence of the assumed personality; and
estimate a user emotion on the basis of user state information acquired from the user, and, in accordance with the user emotion, change the dialogue control information in the integrated prompt information to adjust at least one of an expression style and content of the response sentence of the assumed personality; and
output, via an output device, the generated response sentence and visual information or auditory information corresponding to the memory elements, and thereby reproduce past experiences for the user as a virtual reunion.

### (Supplementary 2)

The system according to supplementary 1,
wherein the processor is configured to
use, as the external information processing apparatus, an information supply system including a plurality of information providing services, and acquire the electronic information by executing data linkage processing based on authentication information and authorization control information.

### (Supplementary 3)

The system according to supplementary 1,
wherein the processor is configured to
express events relating to the user as a narrative structure in accordance with temporal information and relationship information through generation of the response sentence by the dialogue data processing model and presentation of the context information based on the memory elements, and accumulate the narrative structure as a history of continuous dialogue, thereby realizing the virtual reunion experience as a personal narrative of the user.

### Application Example 1

### (Supplementary 1)

A system comprising a processor,
wherein the processor is configured to
acquire, via communication with an external apparatus, multiple types of electronic information relating to an individual or a group and to perform format conversion, structuring, and feature extraction on the acquired electronic information so as to store the electronic information as memory representation data, and
perform information processing on the memory representation data, the information processing including language processing computation, image processing computation, audio processing computation, and similarity calculation computation, so as to generate memory structure data representing relationships among events, entities, locations, and times, and to execute inference processing including a generative AI model based on the memory structure data and the memory representation data so as to generate dialogue persona profile data, and
convert a prompt sentence received from a user into a semantic representation based on the dialogue persona profile data and the memory structure data, search for memory representation data corresponding to the semantic representation on the basis of similarity, construct prompt data to be input to the generative AI model by using the searched memory representation data and the dialogue persona profile data as context, and cause the generative AI model to generate dialogue response data, and
perform control processing on the dialogue response data, the control processing including language expression adjustment processing, content restriction processing, and temporal consistency verification processing, so as to generate adjusted dialogue response data as information data for output, and
transmit the information data to a terminal apparatus and, via display output or audio output by the terminal apparatus, provide the user with a re-experiencing of events through dialogue with a virtual persona.

### (Supplementary 2)

The system according to supplementary 1,
wherein the processor is configured to
acquire the multiple types of electronic information relating to the individual or the group by data linkage using an application programming interface provided by an external information processing apparatus, perform preprocessing on acquired image information, video information, audio information, and character information in accordance with a medium type of each piece of information, and manage the preprocessed information in a unified manner as the memory representation data.

### (Supplementary 3)

The system according to supplementary 1,
wherein the processor is configured to
generate narrative structure data by arranging, along a time axis, the dialogue response data and associated memory representation data based on the dialogue persona profile data and the memory structure data and based on a plurality of prompt sentences input from the user in chronological order, and present the narrative structure data via the terminal apparatus so that dialogue with the virtual persona is experienced by the user as the user's own narrative.

### Example 2

### (Supplementary 1)

A system comprising a processor,
wherein the processor is configured to
acquire information relating to a user and information relating to a group associated with the user through information linkage with an external apparatus, and store the acquired information in a storage area as temporal information, attribute information, and medium-type information, and execute feature extraction processing, recognition processing, and summarization processing on a plurality of types of information including image information, moving-image information, audio information, and character information stored in the storage area, and generate, on the basis of results of the processing, a memory information set corresponding to an assumed persona and a personality characteristic information set corresponding to the assumed persona, and
construct or adjust a generative artificial intelligence model by using the memory information set and the personality characteristic information set as learning data, and build a persona model of the assumed persona by causing the generative artificial intelligence model to reflect a speaking style, emotional tendency, and relational characteristic of the assumed persona, and search, on the basis of the memory information set, for memory information having semantic similarity with a prompt sentence input by the user, and generate context information including the prompt sentence and the memory information, and
input the context information to the persona model and generate a dialogue text that responds to the prompt sentence, and
generate audio data and visual display control data on the basis of the dialogue text, and cause a terminal device to perform audio output and visual display corresponding to the assumed persona so as to present a virtual reunion experience, and
accumulate, in the storage area as a dialogue history, a plurality of prompt sentences continuously input by the user and the dialogue text, and add the dialogue history to the context information to update subsequent dialogue text generation.

### (Supplementary 2)

The system according to supplementary 1,
wherein the processor is configured to
in the feature extraction processing, extract face feature amounts, scene feature amounts, and object feature amounts from the image information and the moving-image information, extract audio segments, speaker feature amounts, and prosodic feature amounts from the audio information, and extract lexical feature amounts, emotional feature amounts, and topic feature amounts from the character information, and store the extracted feature amounts in association with the memory information set and the personality characteristic information set.

### (Supplementary 3)

The system according to supplementary 1,
wherein the processor is configured to
in generation of the context information, convert the prompt sentence into a vector representation, select a plurality of pieces of memory information on the basis of similarity between the vector representation of the prompt sentence and vector representations of the memory information set, reconstruct the selected memory information as descriptive sentences indicating events of the user, input the descriptive sentences and the prompt sentence to the generative artificial intelligence model, and present the dialogue text as a virtual reunion experience structured as a narrative of the user.

### Application Example 2

### (Supplementary 1)

A system comprising a processor,
wherein the processor is configured to
acquire, via a communication interface, a group of digital information items related to a user, to classify the group of digital information items by type, to perform preprocessing for each type, to extract feature values from the group of digital information items, and to integrate the feature values as memory information,
to generate, on the basis of the integrated memory information, a prompt sentence to be input to a generative AI model for dialogue generation, to input the prompt sentence to the generative AI model, and to generate, as an output from the generative AI model, an assumed persona profile including characteristic information and dialogue policy information of a virtual persona related to the user,
to acquire voice information and image information of the user, to estimate an emotional state of the user by using an emotion analysis model on the basis of the voice information and the image information, to add the emotional state as a dialogue generation condition to the assumed persona profile, and to dynamically update the prompt sentence to be input to the generative AI model in accordance with the emotional state,
to generate, on the basis of the assumed persona profile, utterance content of the user, the emotional state of the user, and dialogue history, a prompt sentence to be input to the generative AI model, and to output, as a dialogue from the virtual persona, a response sentence acquired from the generative AI model,
to generate, on the basis of the group of digital information items and the assumed persona profile, three-dimensional virtual environment information simulating a past experience scene, and to provide the three-dimensional virtual environment information to an output device so as to present to the user a virtual reunion scene with the virtual persona, and
to update, during presentation of the virtual reunion scene, the prompt sentence and the three-dimensional virtual environment information in accordance with behavior information and the emotional state of the user acquired during the presentation, thereby sequentially changing the virtual reunion scene as a personal experience story of the user.

### (Supplementary 2)

The system according to supplementary 1,
wherein the processor is configured to acquire the group of digital information items by using a data linkage mechanism with an external storage apparatus or an external service, and to store the acquired group of digital information items in a storage apparatus.

### (Supplementary 3)

The system according to supplementary 1,
wherein the processor is configured to update, during presentation of the virtual reunion scene, the prompt sentence to be input to the generative AI model on the basis of selection operations and utterance content of the user, and to control dialogue content by the virtual persona and the three-dimensional virtual environment information such that a narrative structure of the virtual reunion scene differs for each user.

What is claimed is:

1. A system comprising:
a communication interface coupled to a packet-switched network;
a storage device; and
circuitry configured to:
acquire, via the communication interface, entity-related electronic information from one or more external information processing systems, store the electronic information in the storage device, preprocess the electronic information by performing multimodal analysis comprising language analysis on textual and audio content to extract expression-tendency information and emotion-tendency information, and feature extraction on image and video content to extract subject-feature information and scene-feature information, and integrate the extracted information to generate personality information;
construct, based on the personality information and the electronic information, a dialogue data processing model serving as an assumed personality by using a generative neural network model, and store the dialogue data processing model in the storage device;
generate, for memory elements derived from the electronic information, description information, convert the description information into feature vectors by vectorization processing, and store the feature vectors in a memory index structure configured for similarity search;
receive, from a terminal device via the communication interface, a prompt sentence as user input, convert the prompt sentence into a prompt feature vector, perform similarity search on the memory index structure using the prompt feature vector to identify memory elements related to the prompt sentence, and generate integrated prompt information by combining dialogue control information corresponding to the assumed personality, context information based on the identified memory elements, and the prompt sentence;
input the integrated prompt information to the generative neural network model to generate a response sentence; and
analyze an emotional state of the user based on the user input, and adjust at least one of a response content parameter, a response tone parameter, and a dialogue progression parameter of the integrated prompt information based on the analyzed emotional state.

2. The system according to claim 1, wherein the circuitry is further configured to:
perform the language analysis by applying a natural language processing pipeline comprising tokenization, syntactic parsing, and semantic embedding generation to textual content, and applying speech feature extraction comprising pitch contour analysis, speaking rate measurement, and energy envelope extraction to audio content.

3. The system according to claim 2, wherein the circuitry is further configured to:
perform the feature extraction on image content by applying a convolutional neural network to extract subject-feature information comprising facial feature vectors and object recognition labels, and on video content by applying temporal segmentation and frame-level feature extraction to produce scene-feature information comprising activity descriptors and temporal context tags.

4. The system according to claim 3, wherein the circuitry is further configured to:
integrate the expression-tendency information, the emotion-tendency information, the subject-feature information, and the scene-feature information into the personality information by constructing a multi-dimensional attribute vector, and store the multi-dimensional attribute vector in the storage device as a structured personality profile.

5. The system according to claim 4, wherein the circuitry is further configured to:
construct the dialogue data processing model by generating a system-level instruction prompt comprising the structured personality profile, characteristic expression patterns, topic preference indicators, and relational context descriptors, and supplying the system-level instruction prompt to the generative neural network model as persistent context for subsequent dialogue sessions.

6. The system according to claim 5, wherein the circuitry is further configured to:
update the structured personality profile by incorporating new electronic information acquired via the communication interface, recomputing the multi-dimensional attribute vector, and regenerating the system-level instruction prompt to reflect updated personality characteristics.

7. The system according to claim 1, wherein the memory index structure comprises an approximate nearest neighbor index built from the feature vectors, and wherein the similarity search comprises computing a distance metric between the prompt feature vector and the stored feature vectors and returning memory elements within a predetermined distance threshold.

8. The system according to claim 7, wherein the circuitry is further configured to:
rank the identified memory elements by a relevance score computed as a weighted combination of the distance metric and a recency factor derived from temporal metadata associated with each memory element; and
select a top-k subset of the ranked memory elements for inclusion in the context information.

9. The system according to claim 8, wherein the circuitry is further configured to:
generate a natural language summary of each selected memory element by inputting the description information of each selected memory element to the generative neural network model with a summarization instruction prompt; and
concatenate the natural language summaries into the context information portion of the integrated prompt information.

10. The system according to claim 1, wherein the circuitry is further configured to:
analyze the emotional state of the user by applying an emotion classification model to at least one of text data, audio feature data, and image feature data derived from the user input, the emotion classification model outputting a categorical emotional state label and a confidence score.

11. The system according to claim 10, wherein the emotional state label is mapped to coordinates on a valence-arousal space, and wherein the circuitry adjusts the response tone parameter by selecting a tone modifier corresponding to a region of the valence-arousal space in which the emotional state falls.

12. The system according to claim 11, wherein the circuitry is further configured to:
maintain an emotion trajectory in the storage device comprising a sequence of emotional state labels over consecutive exchanges in a dialogue session; and
detect a transition pattern in the emotion trajectory and adjust the dialogue progression parameter to steer the response sentence toward a narrative progression aligned with the detected transition pattern.

13. The system according to claim 12, wherein the circuitry is further configured to:
train an autoencoder neural network on historical emotion trajectory data to establish a baseline reconstruction error distribution, and detect an anomaly in a current emotion trajectory when a reconstruction error exceeds a predetermined threshold, the detected anomaly triggering a modification of the dialogue control information to prioritize stabilization of the emotional state.

14. The system according to claim 1, wherein the circuitry is further configured to:
maintain a dialogue history in the storage device comprising the prompt sentence, the identified memory elements, the integrated prompt information, and the response sentence for each exchange; and
apply a sliding window to the dialogue history to construct a contextual prefix for subsequent integrated prompt information, the sliding window retaining a fixed number of most recent exchanges.

15. The system according to claim 14, wherein the circuitry is further configured to:
generate a compressed summary of exchanges outside the sliding window using the generative neural network model, and prepend the compressed summary to the contextual prefix to preserve long-range narrative continuity.

16. The system according to claim 1, wherein the circuitry is further configured to:
receive, from the terminal device via the communication interface, feedback data indicating a quality assessment of the response sentence; and
store the feedback data in the storage device in association with the corresponding integrated prompt information and response sentence, and update the dialogue control information based on aggregated feedback data to implement a closed-loop behavioral feedback mechanism.

17. The system according to claim 16, wherein the circuitry is further configured to:
compute an engagement metric representing a ratio of user-initiated exchanges to total exchanges over a session duration, and adjust the response content parameter to increase narrative depth when the engagement metric exceeds a threshold and to increase interactive prompting when the engagement metric falls below the threshold.

18. A system comprising:
a communication interface coupled to a packet-switched network;
a storage device; and
circuitry configured to:
acquire, via the communication interface, entity-related electronic information, preprocess the electronic information by performing multimodal analysis comprising language analysis to extract expression-tendency and emotion-tendency information, and image and video feature extraction to extract subject-feature and scene-feature information, and integrate the extracted information into a structured personality profile;
construct a dialogue data processing model by generating a system-level instruction prompt comprising the structured personality profile, characteristic expression patterns, and relational context descriptors, and storing the instruction prompt in the storage device;
generate feature vectors for memory elements derived from the electronic information, store the feature vectors in an approximate nearest neighbor index, receive user input from a terminal device, convert the user input into a prompt feature vector, perform similarity search to identify related memory elements, rank the memory elements by a weighted relevance score, and generate integrated prompt information combining the dialogue data processing model, context information from the ranked memory elements, and the user input;
input the integrated prompt information to a generative neural network model to generate a response sentence, analyze an emotional state of the user by applying an emotion classification model to the user input to produce an emotional state label, and adjust at least one of a response tone parameter and a dialogue progression parameter based on the emotional state label; and
transmit the response sentence to the terminal device via the communication interface and store a dialogue history comprising the integrated prompt information and the response sentence.

19. The system according to claim 18, wherein the circuitry is further configured to:
maintain an emotion trajectory comprising a sequence of emotional state labels, detect transition patterns in the emotion trajectory, and adjust the dialogue progression parameter to align narrative progression with the detected transition patterns.

20. A method comprising:
acquiring, via a communication interface coupled to a packet-switched network, entity-related electronic information, preprocessing the electronic information by performing multimodal analysis to extract expression-tendency information, emotion-tendency information, subject-feature information, and scene-feature information, and integrating the extracted information to generate personality information;
constructing a dialogue data processing model serving as an assumed personality based on the personality information by using a generative neural network model;
generating feature vectors for memory elements derived from the electronic information, storing the feature vectors in a memory index structure, receiving a prompt sentence from a terminal device, converting the prompt sentence into a prompt feature vector, performing similarity search to identify related memory elements, and generating integrated prompt information combining dialogue control information, context information from the identified memory elements, and the prompt sentence;
inputting the integrated prompt information to the generative neural network model to generate a response sentence;
analyzing an emotional state of a user based on the prompt sentence, and adjusting at least one of a response content parameter, a response tone parameter, and a dialogue progression parameter of the integrated prompt information based on the analyzed emotional state; and
transmitting the response sentence to the terminal device via the communication interface.
